(19) United States
(12) Patent Application Publication
(10) Pub. No.: US 2004/0159700 A1
(43) Pub. Date: Aug. 19, 2004

(54) Method and apparatus for secure import of information into data aggregation program hosted by personal trusted device

(75) Inventors: Mohammad A. Khan, San Jose, CA (US); Jorge M. Fernandes, Los Altos Hills, CA (US); Kerry D. Brown, Los Altos Hills, CA (US); Stan J. Simon, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VIVOtech, Inc., Santa Clara, CA

(21) Appl. No.: 10/428,910

(22) Filed: May 2, 2003

Related U.S. Application Data
(63) Continuation-in-part of application No. 10/327,638, filed on Dec. 19, 2002.
Application No. 10/327,638 is a continuation-in-part of application No. 10/306,618, filed on Nov. 27, 2002.
(60) Provisional application No. 60/411,536, filed on Sep. 17, 2002.
(60) Provisional application No. 60/343,874, filed on Dec. 26, 2001.
(60) Provisional application No. 60/382,280, filed on May 20, 2002.
(60) Provisional application No. 60/345,985, filed on Dec. 31, 2001.

(51) Int. Cl. G06K 5/00

(52) U.S. Cl. 235/380

(57) ABSTRACT

Embodiments in accordance with the present invention allow financial or other confidential information to be securely imported in electronic form into a PTD. The information to be imported is first encrypted. The encrypted information is then transmitted from a source to the PTD. The encrypted information is then stored by the PTD. A decryption key is sent to the PTD user in a manner establishing a strong non-repudiation scheme. For example, the decryption key could be sent from a second device, or through a second communication channel separate and distinct from the first communication channel. Utilizing the decryption key delivered through the second communication channel, the user is able to decrypt and access the information in the PTD for transactional purposes.

### CROSS-REFERENCES TO RELATED APPLICATIONS

The instant nonprovisional patent application is a continuation-in-part of U.S. nonprovisional patent application Ser. No. 10/327,368, filed Dec. 19, 2002, which is in turn a continuation-in-part of U.S. nonprovisional patent application Ser. No. 10/306,618, filed Nov. 27, 2002, which claims priority from the following provisional patent applications: U.S. provisional patent application No. 60/343,874, filed Dec. 26, 2001, U.S. provisional patent application No. 60/345,985, filed Dec. 31, 2001, U.S. provisional patent application No. 60/382,280 filed May, 20, 2002. The instant nonprovisional patent application also claims priority as a nonprovisional application of U.S. provisional patent application No. 60/411,536 filed Sep. 17, 2002. All of these prior applications are hereby incorporated by reference for all purposes.

### BACKGROUND OF THE INVENTION

The concept of magnetic stripe credit cards was generally embraced by merchants and consumers when standards were adopted by the industry in the 1970's. The International Airline Transport Association (IATA) and the American Banking Association (ABA) defined the standards for magnetic domain encoding for tracks 1 and 2, respectively, of magnetic stripe cards. A third track of magnetic stripe cards is still used by some organizations such as ATM machines for read and write functions, and utilizes unique organization encoding schemes. The International Standards Organization (ISO/IEC 7811) established standards for the architectural design and acceptable materials composition of magnetic stripe cards.

Electronic/computer “RF proximity chip cards” introduced in the late 1980s were originally used for applications such as inventory control. ISO standards 15693 and 14443, sub type A and B, typically define such characteristics of RF proximity chip cards that include operational frequencies, electromagnetic coupling distance, and data integrity. These RF proximity chip cards have now increased in popularity for use with employee access to secure areas such as office buildings. The RF proximity chip cards typically receive power for on-card electronic functions via an induced electromagnetic field held within about 10 cm of the communications transceiver. Data is typically transferred to the on-card chip via electromagnetic sub-carriers and switching of the electromagnetic field.

The integrated circuits resident within these RF proximity chip cards have continued to improve with low power and the addition of cryptographical functions that now meet government “strong” encryption standards (DES, RSA, etc.) as standardized by Europay Mastercard and Visa (EMV) cryptographic and tamper-proof standards for crytoprocessor chips. As a result, the RF proximity chip cards are slowly replacing the magnetic stripe card for use in financial transactions, primarily due to the security of the magnetic stripe user data and the ability of the POS card acceptance system to “interrogate” the RF proximity chip card. The lower fraudulent transactions associated with such a smart card results in lower risk, and lower fees for the consumer and merchant.

Even more recently, the increased speed and reduced size of electronic devices has resulted in the proliferation of powerful and portable personal trusted devices, or PTDs. Mobile PTDs including the personal digital assistant (PDA) and cellular phone now number in the millions worldwide. The ability of these PTDs to communicate via cellular and wireless ISP networks has been augmented by their ability to exchange data over short ranges, typically 1 mm-10 meters, for purposes of secure data sharing between PTD devices and such peripheral devices as printers in addition to other PTDs. These short-range networks are typically referred to as personal area networks (PAN). One predominant short-range RF communications network standard, defined by the International Electrical and Electronic Engineers association (IEEE), is known as the IEEE 802.11(b) standard, and includes such protocols as BLUETOOTH. Other RF communications protocols include but are not limited to IEEE 802.11(a) and 802.11(g). A major short-range infra-red (IR) communications network protocol, defined by the Infra-red Device Association (IrDA), is known as the IrDA standard and their present specification is IrDA v1.2.

The variety of functions available to PTDs is increasing rapidly, for example with remote banking being popularized via the internet and telephone ordering. Many merchants are now able to use mobile transaction processing systems with cellular wireless ISP networks providing bank access and such support functions as consumer authentication, transaction authorization, event logging, and settlement. Consumers are now able to access and effect personal account maintenance functions via bank websites and similar portals, and to manipulate information utilizing financial data aggregation (FDA) software programs hosted on their mobile personal trusted devices (PTDs).

Despite these advancements, there remain obstacles to the convenient and efficient utilization of financial and other types of personal information in electronic form. For example, the magnetic stripe of a conventional plastic credit card contains a magnetically readable code associated with the specific credit account of the card holder. This code is relatively simple and readily converted into an alternative electronic format, for example a bit string stored on the user's personal trusted device (PTD). In such a manner, a user should be able to avoid the bulk and clutter associated with having to carry a number of plastic cards.

Possession, however, of the credit card code by an unauthorized party could lead to fraudulent purchases. Accordingly, credit card issuers and other financial institutions are reluctant to allow the importation of sensitive information into PTDs, owing primarily to security concerns.

Accordingly, there is a need in the art for methods and apparatus allowing for secure importation of financial and other personal information into personal trusted devices.

### BRIEF SUMMARY OF THE INVENTION

Embodiments in accordance with the present invention allow financial or other confidential information to be securely imported in electronic form into a PTD. The information to be imported is first encrypted. The encrypted information is then transmitted from a source to the PTD, for example a wired or wireless data communications network. The encrypted information is then stored by the PTD. A decryption key is sent to the PTD user Utilizing the decryption key, the user is able to decrypt and access the information on the PTD for transactional purposes. In accordance with one embodiment, the encrypted information and the decryption key are communicated to the PTD over separate and distinct communication channels to establish a strong non-repudiation scheme. For example, the encrypted information may be sent electronically, and the decryption key sent to the user by mail. In accordance with another embodiment of the present invention, the encrypted information and the decryption key are communicated to the PTD from different devices to establish a strong non-repudiation scheme. For example, the encrypted information may be communicated from a server, and the decryption key may be communicated from a CD ROM or other storage medium.

In accordance with one embodiment of the present invention, secure importation of information from a magnetic stripe card or a second PTD may be facilitated by an interface device configured to receive the information, to encrypt the received information, and then to transmit the encrypted information to the PTD. In accordance with another embodiment of the present invention, information from the magnetic stripe of a conventional credit card may be imported into a PTD and then decrypted utilizing a key embedded in the billing statement periodically mailed to the PTD user. In accordance with still another embodiment of the present invention, access to the decrypted information may be further limited by additional security mechanisms, for example requiring reentry of a personal information number (PIN) originally established during the importation process.

An embodiment of a method in accordance with the present invention for communicating information to a personal trusted device (PTD), comprises, encrypting information at a source, communicating the encrypted information to a receiver of a PTD through a first communication channel, and storing the encrypted information in a memory of the PTD. A decryption key is transmitted to the PTD through a second communication channel different from the first communication channel, and the decryption key is utilized to decrypt the information.

An embodiment of a method of communicating information to a personal trusted device (PTD), comprises, communicating encrypted information to a receiver of a PTD from a first device, and storing the encrypted information in a memory of the PTD. A decryption key is communicated to the PTD from a second device, and the decryption key is utilized to decrypt the information.

An embodiment of a method of activating a credit card account for use on a personal trusted device (PTD), comprises, storing in a memory of the PTD encrypted data identifying a credit card account number, entering a decryption key into the PTD, and decrypting the data with the decryption key.

An embodiment of an apparatus in accordance with the present invention for importing information into a personal trusted device, comprises, a receiver configured to receive information from a source, a memory in electronic communication with the receiver and configured to store the information, and a processor in electronic communication with the memory and configured to encrypt the information. The apparatus further comprises a short range wireless transmitter in electronic communication with the memory and configured to transmit the encrypted information to a PTD.

A further understanding of the embodiments of the present invention can be made by way of reference to the ensuing detailed description taken in conjunction with the accompanying drawings.

### BRIEF DESCRIPTION OF THE DRAWINGS

FIG. 1 shows a simplified exploded view of an adaptor system in accordance with one embodiment of the present invention.

FIG. 1A shows a simplified enlarged view of the module underside of the embodiment shown in FIG. 1.

FIG. 1B shows a perspective view of a simulacrum in accordance with an embodiment in accordance with the present invention, as positioned in a POS magnetic stripe card reader.

FIG. 2 shows a simplified enlarged side view of the simulacrum structure of FIG. 1.

FIG. 3 shows a simplified exploded view of the simulacrum structure of FIGS. 1-2.

FIG. 4 shows a simplified enlarged view of the inductor core elements of the embodiment shown in FIGS. 2-3.

FIG. 4A shows a simplified end view of a slot of a magnetic stripe card reader containing the simulacrum and a magnetic stripe card.

FIG. 5 shows a simplified block diagram illustrating functionality of an embodiment of an adaptor in accordance with the present invention.

FIG. 6 shows a simplified perspective view of an alternative embodiment of an adaptor structure in accordance with the present invention.

FIGS. 7A-B show simplified perspective views of another alternative embodiment of an adaptor structure in accordance with the present invention.

FIG. 8 shows a perspective view an alternative embodiment of an inductor structure for longitudinal indexing in accordance with the present invention.

FIG. 9 is a simplified logical diagram of the installation of an adaptor to a magnetic stripe card acceptance system.

FIG. 10 is a simplified logical diagram of the interface process between an adaptor and a ViVOwallet application.

FIG. 11 is a simplified logical diagram of the interface process between an adaptor magneto-inductive structure and a magnetic card swipe/insert acceptance system.

FIG. 12 is a simplified logical diagram of the user visual/audio cue process between an adaptor and a user PTD having the ViVOwallet financial management application.

FIG. 13 shows a simplified descriptive diagram of the ViVOwallet™ financial management application.

FIG. 14 is a simplified descriptive diagram of the ViVOserver™ data management system.

FIG. 15 is a simplified component diagram of physical devices and systems utilized to implement an embodiment of an adaptor in accordance with the present invention.

FIG. 16 is a simplified functional diagram of physical devices and systems utilized to implement the embodiment of FIG. 15.

FIG. 17 is a simplified block diagram summarizing functionality of major components of an embodiment of an adaptor in accordance with the present invention.

FIG. 18A shows a simplified perspective view of one embodiment of an adaptor in accordance with the present invention for use in securely imparting financial information into a user's PTD.

FIG. 18B shows a simplified rear view of the adaptor shown in FIG. 18A.

FIG. 19 shows a simplified flowchart of steps of a process in accordance with the present invention for loading the ViVOwallet™ financial management software application into a PTD.

FIG. 20 shows a simplified flow chart of steps of a process in accordance with the present invention for securely importing financial information into a user's PTD utilizing the ViVOloader device.

FIG. 21 shows a simplified flowchart of steps of a process in accordance with the present invention for preparing encrypted imported information for use in a transaction.

FIG. 22 shows a simplified chart of a number of different approaches for providing a ViVOwallet or other financial aggregation computer program to a PTD.

FIG. 23 is a simplified schematic diagram illustrating secure importation of information into a PTD.

### DETAILED DESCRIPTION OF THE INVENTION

As used herein, the term personal trusted device (PTD) refers to a device having processing and storage capabilities allowing it to host and operate a data aggregation software application useful for managing and manipulating information. Devices falling within this definition may or may not include a display or keyboard, and include but are not limited to cell phones, wireless communication tablets, personal digital assistants, RF proximity chip cards, and laptop personal computers.

In accordance with embodiments of the present invention, a PTD may securely import information from a source utilizing encryption technology. The information to be imported is first encrypted. The encrypted information is then transmitted from a source to the PTD. The encrypted information is then stored by the PTD. Prior or subsequent to communication of the encrypted information, a decryption key is sent to the PTD user through a separate communication channel or utilizing a second device in order to establish a strong non-repudiation scheme.

In accordance with one embodiment of the present invention, a PTD may securely import information from a source such as a magnetic stripe card or a second PTD utilizing an interface device. The interface device includes a receiver for receiving information from the source, and a short-range wireless transceiver such as an IR transceiver for communicating with the PTD. The interface device may also feature a cryptoprocessor including an embedded encryption key. Information communicated from the source to the interface device is encrypted with the key and then transmitted to the PTD in encrypted form. The user of the PTD may then decrypt the imported information using a corresponding decryption key communicated to the user through a separate channel. For example, the decryption key may be mailed to the home address of the PTD user as part of a periodic credit card billing statement.

The following section introduces the concept of a device that is configured to emulate a magnetic stripe card signal for recognition by a conventional magnetic stripe card reader. Subsequent sections discuss the secure importation of information, for example from a magnetic card, for use in a financial data aggregation (FDA) software program hosted by a user's PTD, and also discuss features of such an exemplary FDA software program.

### I. Emulation of Magnetic Stripe Card Information

An adaptor in accordance with the present invention allows a conventional magnetic stripe card reader to interact with other media such as RF proximity chip cards and Infra-Red while retaining the continuous ability to receive a magnetic stripe card. In accordance with one embodiment, the adaptor includes a simulacrum structure of sufficiently narrow dimensions to fit substantially permanently within the slot of the magnetic stripe reading device, while providing sufficient room for a magnetic stripe card to also be accommodated with the slot. The simulacrum structure may be in electronic communication with one or more transceivers of wireless media such as RF and IR.

For purposes of the instant patent application, the term “substantially permanent” refers to affixing an adaptor to a conventional magnetic stripe card POS device for relatively long periods, such that the adaptor is not routinely removed to allow the use of a magnetic stripe card. Examples of substantially permanent installation of the adaptor include but are not limited to the use of gluing/adhesion, mechanical fasteners, plastic welding, wedge anchors, or other physical bonding techniques. Such substantially permanent installation allows the adaptor to function in conjunction with the existing magnetic stripe card reader without requiring invasive modification or alteration of the reader or its normal capabilities. Substantially permanent installation of an adaptor in accordance with an embodiment of the present invention is reversible, and under other than routine conditions the adaptor may be removed to allow inspection, repair, or replacement without damage to the existing magnetic stripe reader device.

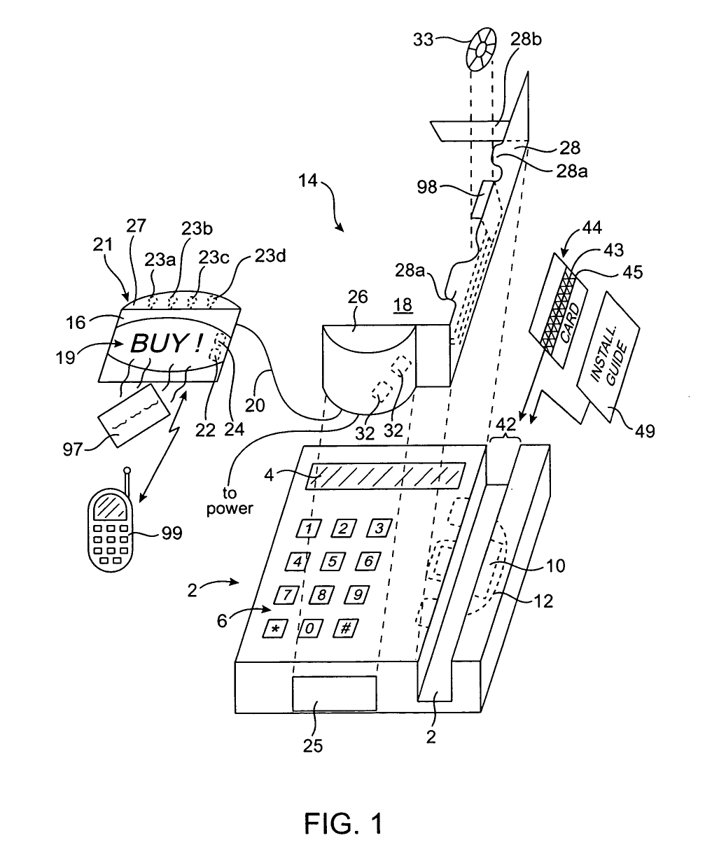

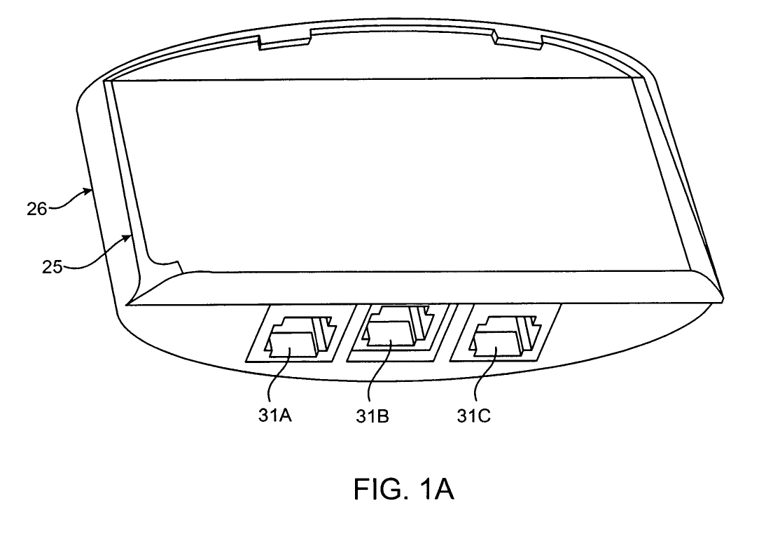

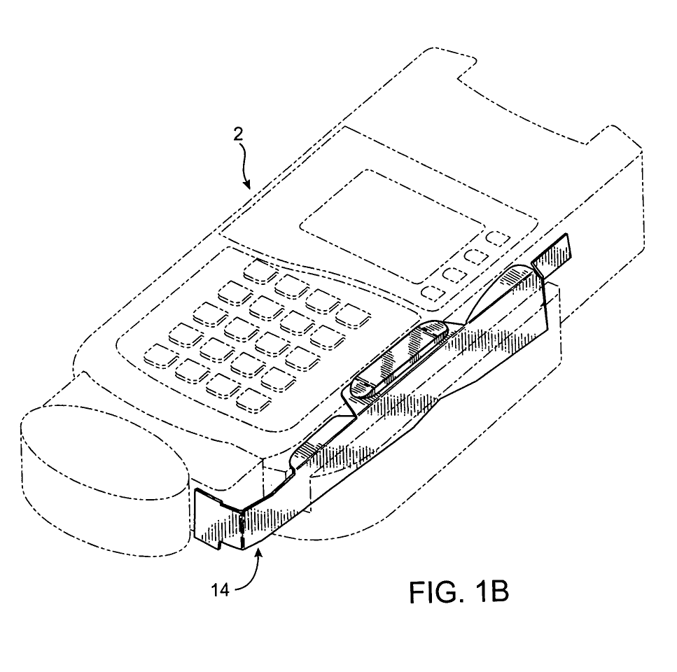

FIG. 1 shows an exploded view of an adaptor system (hereafter also referred to as the “ViVOadapter”) in accordance with one embodiment of the present invention. Conventional point-of-sale (POS) magnetic stripe card reader 2 features display 4, keypad 6, and magnetic card swipe slot 8. Magneto-inductive reader head 10 is flexibly supported by leaf spring 12 to project slightly into slot 8.

Adaptor 14 comprises consumer pod (C-Pod) portion 16 in electrical communication with merchant pod (M-Pod) portion 18 through cable 20. Consumer pod portion 16 is positioned at a location convenient for the customer, who may interact with the adaptor 14 by bringing an RF proximity chip card 97, PTD 99, or other RF or IR transceiver device in proximity to a wireless transceiver 22 to communicate information.

C-Pod portion 16 includes active region 19 proximate to an antenna for interacting at short range with an RF proximity chip card or other personal trusted device. Active region 19 may be of concave shape to cue a user as to the optimal position of the RF proximity chip card in front of the antenna. Particular embodiments of the C-Pod may bear an advertising logo on the active region 19 as generically indicated in FIG. 1. One possible design of a C-Pod structure in accordance with an embodiment of the present invention is depicted in U.S. design patent application Ser. No. 29/168,943, filed Oct. 10, 2002 (Atty. Docket No. 021633-000200US) which is incorporated by reference herein for all purposes.

C-Pod portion 16 may further include visual display region 21. In one embodiment, four discrete light emitting devices 23a-d are positioned behind translucent screen 27 of C-Pod portion 16 and then selectively lit to indicate progress of a particular transaction. For example, left-most lamp 23a may be continuously lit to indicate an active power connection. Lamps 23b and 23c may lit to indicate detection of the presence of an RF proximity chip card or other user device. Right-most lamp 23d may be lit to indicate completion of a successful transaction. Embodiments of C-pod portion 16 may also include apparatus for providing audio indicia of transaction progress, for example a speaker which emits a sound after successful completion of the transaction. Typical operation of video and audio indicia is further detailed below in connection with FIG. 12.

C-Pod portion 16 further comprises one or more transceivers 22 in communication with respective interface processors 24. One example of a transceiver which may be located in the consumer pod portion is an infrared (IR) transceiver supporting Irda v.1.2 and higher standards for inter-device bi-directional communications. This IR transceiver is of particular value for communicating with personal trusted devices (PTD) that may be carried by a consumer or user. Another example of a transceiver that may be located in the consumer pod portion is a radio frequency proximity transceiver conforming to the ISO 14443 type A or B standard or to the ISO 15693 standard. Still another example of a transceiver that may be located in the consumer pod portion is a transceiver conforming to the BLUETOOTH standard, or to IEEE 802.11(a), 802.11(b), and (g) standards. Yet another example of a transceiver that may be located in the C-Pod portion is a wireless transceiver configured for wireless or cellular protocols based upon CDMA, CDPD, GPRS, GSM, SMS and similar wireless communication protocols.

While the above description has focused on the presence of one or more wireless transceivers in the consumer pod portion of the adaptor, this is not required by the present invention. In alternative embodiments, the consumer pod portion could feature one or more contact-based interfaces for interacting with a consumer transaction card or smart card. One example of such a system is a modular-based docking port for a smart card. Other embodiments could include both wireless and contact-based transceivers.

In addition to the wireless or contact-based transceivers just described, an adapter in accordance with an embodiment of the present invention could further comprise one or more additional specialized interfaces. Examples of such additional interfaces include but are not limited to a keyboard permitting the entry of psychometric devices such as a personal identification number (PIN) pin pads, and SMS transfer of PIN, bio-metric devices such as finger print, iridology, voice print analyzers, driver's license identifications, or transconductance cards currently being developed, and devices for reading code sets such as bar codes, UPS-type 3-D codes, moire-pattern codes, and drivers license magnetic strips and holograms, and SIM/WIM/UIM subscription identifier chips typically used in cellular PTD devices. One or more of these interfaces, alone or in combination, could require additional verification or authentication of the user, thereby adding levels of security to the transaction.

While the above description has focused on the presence of separate and discreet consumer pod and merchant pods with interconnecting cable, this configuration is not required by the present invention. In alternative embodiments, the consumer pod portion could be integrated into the merchant pod portion, creating a complete and single-piece unit. One example of such a system preference would be for merchants with magnetic POS reader systems conveniently located on the transaction counter and within reach of the consumer's PTD. Alternate embodiments could include positioning the separate M-Pod and C-pod components remote from the simulacrum tape that is substantially permanently installed within the card acceptance system reader. Another alternate embodiment could include the positioning of a single piece integrated C-Pod and M-Pod device remote from the simulacrum tape substantially permanently installed within the card acceptance system reader.

As shown in FIG. 1, consumer pod portion 16 is in electrical communication with merchant pod portion 18 through cable 20, although in other possible embodiments the consumer pod and merchant pod could communicate according to infrared or another medium. Merchant pod 18 comprises module 26 in physical contact with the front of magnetic stripe card reader 2 through adapter plate 25. An example of one possible design of a module structure in accordance with an embodiment of the present invention is depicted in U.S. design patent application Ser. No. 29/170,080, filed Oct. 30, 2002 (Atty. Docket No. 021633-000300US) which is incorporated by reference herein for all purposes.

Module 26 is in electrical communication with simulacrum structure 28 positioned within slot 8 of magnetic stripe card reader 2. FIG. 1A shows an inverted, enlarged view of the underside of module 26 showing a number of ports for interfacing with other devices, including port 31c for receiving a power cord, port 31a for receiving a cable from the consumer pod portion, and communications port 31b. The presence of a communications port in the module allows for software upgrades to be implemented in the adaptor, for interface of the adaptor to existing POS systems and merchant networks, for interface to ViVOadapter networks, for interface to wired internet and telecommunications, for interface to vending machine product electromechanical activation and delivery devices/systems, for interface to a stand-alone CPU such as a PC, for peripheral devices that may include printers, displays, keyboards and for wired/wireless transceivers, and for expansion of the adaptor to accommodate devices employing communication utilizing alternative or not-yet-developed media or protocols. In addition to the ports just listed, module 26 of the merchant pod could include other types of ports, including but not limited to peripheral device communications, secondary authentication devices, other ViVOadapters and ViVOadapter networks, and input devices such as bar code scanners, authentication devices, and other code reading devices.

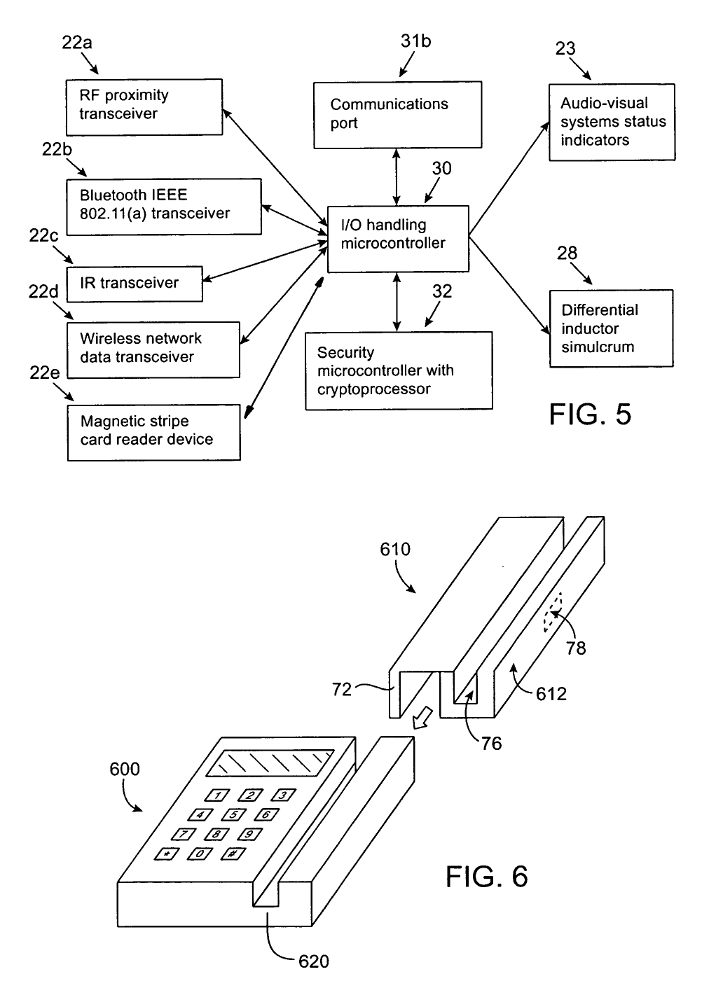

The M-Pod portion may include one or more wireless transceivers configured for wireless or cellular protocols based upon CDMA, CDPD, GPRS, GSM, SMS and similar wireless communication protocols. Module 26 also contains a number of chips including memories and processors responsible for controlling operation of the adaptor. Input/output handling microcontroller 30, shown in FIG. 5, allows the merchant or user to select the communication medium through which a user will interact with the adaptor. The input/output handling microcontroller 30 will also accept unique merchant or user codes and relevant data associated with the merchant/user for identification and non-repudiation schemes. Module 26 further includes security microcontroller 32 including a cryptoprocessor which executes stored cryptographic routines and standards including DES, RSA, DSA, HASH, and other communication standards, and has Public Key Infrastructure (PKI) and digital certificate software features for mutual device authentication, data integrity verification, and secure encryption communications with the user's PTD.

While the above description and figures illustrate an embodiment wherein the M-Pod and C-Pod components represent discrete structures connected by a cable, this is not required by the present invention. Alternative embodiments could incorporate the M-Pod and C-Pod components into a single housing located at the magnetic stripe card reader, or positioned remote from the magnetic stripe card reader and in communication with the simulacrum (discussed below) through a wire or wireless connection.

As stated above, simulacrum 28 is in electronic communication with the module, and in electromagnetic communication with the head of the magnetic stripe card reader. FIG. 1B shows a perspective view of a simulacrum 28 in accordance with an embodiment in accordance with the present invention, as positioned within a slot of a POS magnetic stripe card reader 2. One example of a design of a simulacrum structure in accordance with an embodiment of the present invention, which is compatible with an Omni 3200 magnetic stripe card reader, is depicted in U.S. design patent application Ser. No. 29/171,704, which is incorporated by reference herein for all purposes.

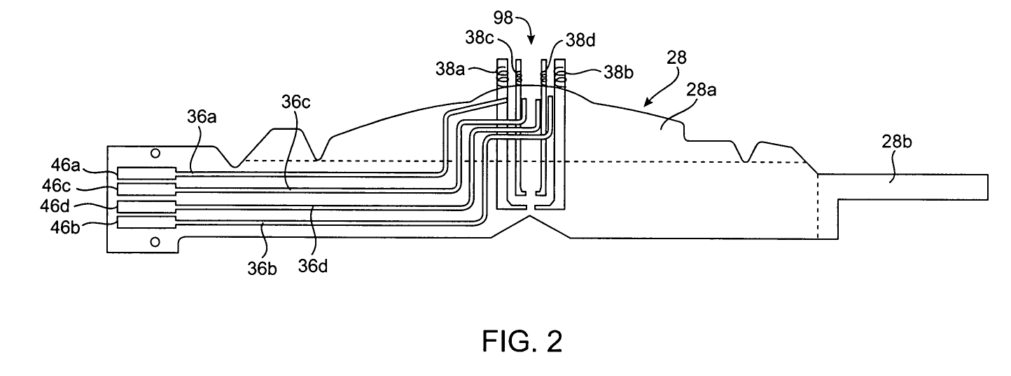

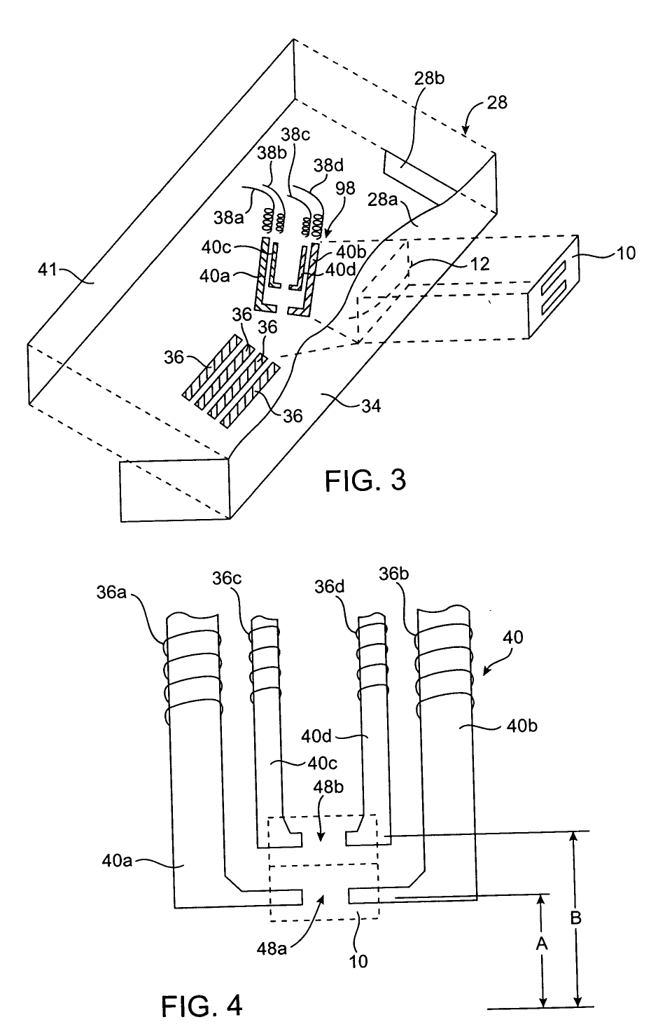

FIG. 2 shows a simplified enlarged side view of the simulacrum structure of FIG. 1, and FIG. 3 shows a simplified exploded view of the simulacrum structure of FIGS. 1-2. Simulacrum 28 comprises dielectric substrate 34 supporting electrically conducting traces 36 and coils 38 in electromagnetic communication with inductor core elements 40, thereby forming inductor structure 98. Substrate 34 may be formed from polycarbonate, as is available from General Electric Plastics of Bergen op Zoom, Holland, or some other deformable but sufficiently stiff material. Traces 36 and coils 38 are typically formed from copper or another conducting metal. Traces 36, coils 38, and inductor core elements 40 may be secured to substrate 34 by being sandwiched between the substrate and an overlying nonconducting film 41 such as Mylar®, available from Du Pont, of Wilmington, Del., or a polycarbonate film as described above.

Inductor core elements 40 may be formed from a variety of materials exhibiting desirable magnetic properties, including but not limited to ferromagnetic materials such as cobalt and alloys thereof. In accordance with one embodiment of the present invention, the inductor core elements comprises a cobalt alloy having an elemental composition of approximately 85% cobalt, 2% iron, 8% silicon, 4% manganese, and about 1% other materials. This material is obtained from Honeywell MetGlas Solutions of Conway, S.C. These percentages represent only an approximation of one particular embodiment, and alternative embodiments could employ other alloys having different compositions.

The materials comprising the cobalt alloy contribute various attributes to the inductor structure. For example, cobalt is a ferromagnetic material that is able to exhibit sufficiently strong electromagnetic fields in response to an induced field proportional to the applied voltage and current to the coils that encompasses the inductor core elements. The silicon contributes structural strength, and the manganese is useful for bonding purposes. The alloy of this particular embodiment is supplied by the manufacturer in a film having a thickness of approximately 0.001″ in a tape 2.0″ wide by 100 feet long.

During operation of the embodiment shown in FIG. 1, the M-Pod component of the ViVOadapter is placed directly adjacent to the POS card swipe reader device, with simulacrum 28 aligned to the magnetic reader head of the existing POS card reader system in such a manner as to maintain continued access to the swipe or insert slot for normal card-reading functions. Specifically, simulacrum 28 is positioned within magnetic swipe slot 8 on the side opposite to magnetic reading head 10, such that gap 42 is defined between simulacrum 28 and magnetic head 10. Gap 42 is of sufficient width to allow slot 8 to simultaneously accommodate both simulacrum 28 and conventional magnetic stripe card 44 having tracks 43 and 45. By exhibiting resilient mechanical properties, substrate 34 serves to protect inductor 40 and traces 36 from abrasion by the repeated sliding of a magnetic card within the slot along the simulacrum and adjacent to magnetic reader head 10. By exhibiting a low coefficient of friction, the simulacrum facilitates movement of the card through the slot with minimal degradation to both the card and the simulacrum.

While the above description and illustrated figures relate to an embodiment of a ViVOadapter structure that is configured to interact with a card having two magnetic stripes, the present invention is not limited to this particular example. A ViVOadapter in accordance with alternative embodiments of the present invention could be modified to emulate signals from a magnetic stripe card having three or an even greater number of magnetic tracks, utilizing substantially the same technology described herein.

The ViVOadapter 14 has a mechanical design to conform to the POS card swipe reader device. During installation, simulacrum 28 may be inserted into slot 8 such that the inductor core element 40 is aligned with the magnetic head. The installation or alignment guide 49 having the same thickness of a magnetic stripe card and temporarily attached to the simulacrum accompanies the simulacrum into the slot 8 within gap 42, pushing simulacrum 28 against the side of the slot, and aligning the inductor 98 to a position directly opposite that of the magnetic head. With guide 49 still present in slot 8, simulacrum 28 may then be secured within slot 8 by folding down upper simulacrum tab portions 28a, including the top of inductor structure 40, to conform with and adhere to the top surface of the reader 2. Cap 33 may be placed over the folded top portion of inductor structure 98 to physically protect the inductor core element ends and the coils wrapped around the inductor core element ends from damage or disturbance. In addition, end simulacrum portion 28b may be folded to conform with and adhere to the rear of the reader 2. Once the simulacrum 28 is secured in the slot, installation guide 49 may be removed.

As just described, an adaptor in accordance with an embodiment of the present invention is designed to adapt to the existing magnetic stripe card reader without requiring modification or alteration of the reader or its normal capabilities. Thus embodiments of the simulacrum in accordance with the present invention may, but are not required to be, substantially permanently fixed within the slot of the magnetic stripe card reader though adhesion of top and end portions of the simulacrum to the housing of the reader, or through other means. Installation of the simulacrum within the existing magnetic stripe card reader is reversible, however, and under non-routine conditions the simulacrum may be removed from the reader for inspection or for replacement due to updating or wear or damage.

A molded plate 25 specially designed to the match the front of a particular POS device may secure module 26 in place. Examples of known POS magnetic stripe card readers to which a plate may be created to facilitate contact include, but are not limited to, the TRANZ and OMNI systems of VeriFone, Inc. of Santa Clara, Calif., the T7, T8, and ICE systems of Hypercom Corporation of Phoenix, Ariz., the NURIT 2085 and 2080 systems of Lipman Electronic Engineering Ltd. of Tel Aviv, Israel, the SUREONE and SUREPOS systems of International Business Machines Corp. of Armonk, N.Y., the ELITE system of INGENICO of Cedex, France, the MAGIC system of SchlumbergerSema of New York, N.Y., the 8000 series of INTELLECT of Brussels, Belgium, and the PAYWARE system of the Trintech Group Plc. of Dublin, Ireland.

FIG. 2 shows an enlarged view of simulacrum 28 of FIG. 1, as viewed from the side opposite the magnetic head of the card reader. Simulacrum 28 includes electrically conducting traces 36a-d in communication with electrical coils 38a-d which wrap around various inductor elements 40a-d, respectively, forming a complete inductor structure 98. Ends of traces 36a-d terminate in respective contacts 46a-d.

FIG. 3 shows an exploded view of simulacrum 28. FIG. 3 shows the relative position of traces 36, inductor core elements 40, and coils 38 relative to magnetic head 10 of card reader 2. FIG. 3 also shows that simulacrum 28 may comprise multiple layers of material. For example, as previously described, the narrow width of the simulacrum allows it to be present in the slot of the magnetic stripe card reader at the same time as a magnetic stripe card. However, repeated contact between the simulacrum and such a card can damage or degrade the simulacrum. Accordingly, in the particular embodiment show in FIG. 3, substrate 34 facing gap 42 could exhibit physical resilience or a low frictional coefficient properties to facilitate repeated sliding of the magnetic card stripe card. Alternatively, the substrate could bear a film exhibiting one or more of these properties.

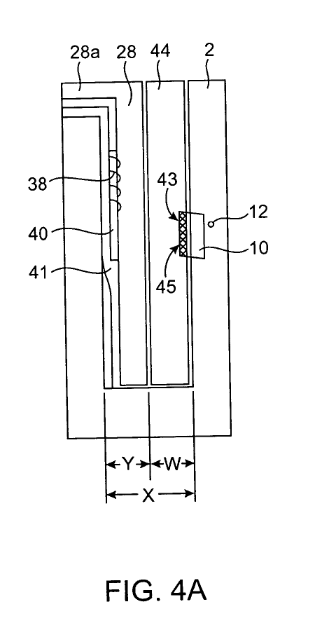

FIG. 4 shows an enlarged view of the differential inductor structure 98 of the simulacrum 28, as viewed from the side opposite the magnetic head 10 of card reader 2, which is shown in broken lines. Differential inductor structure 98 comprises first and second separate and unattached opposing core elements 40a and 40b defining first magneto-inductive gap 48a positioned at a first height “A” corresponding to the expected height of a track of a magnetic stripe of a card inserted within slot 8. Third and fourth separate and unattached opposing core elements 40c and 40d of differential inductor 40 define second magneto-inductive gap 48b positioned at a second height “B” corresponding to the expected height of a second track of a magnetic stripe card inserted within slot 8. Similar arrangement of coil and inductor core elements may be included to emulate additional magnetic card stripe tracks that may be sensed by varieties of magnetic card readers.

Upon communication of a voltage to coils 38a-d encircling portions of inductor core elements 40a-d respectively, magnetic fields exhibiting horizontal magnetic flux domain orientation are generated across gaps 48a and 48b. Such horizontal orientations of the magnetic flux domain of these fields is useful to emulate the orientation of the magnetic domain resulting from movement of the encoded tracks of a magnetic stripe card past the reader head used in the conventional card reader devices.

During operation of the ViVOadapter 14, the magnetic fields created across the magneto-inductive gaps 48a and 48b defined by the simulacrum inductor elements may be controlled by the ViVOadapter microcontroller via connecting traces 36 and contact pads 46. The inductor will receive data in a serial process from the wireless receivers via the wireless interface processor, and in response provide translational magnetic fields at the differential inductor core gaps for emulation of one or more tracks associated with a magnetic card.

An inductor structure in accordance with embodiments of the present invention would be expected to generate a magnetic field having sufficient intensity to couple to the magnetic reader head across the thickness of the substrate and any gap defined between the simulacrum and the reader head. However, the magnetic field produced by the inductor structure should not be so strong as to saturate the head, cause inter-track noise, or cause unwanted coupling with other components of the POS equipment. Thus in particular embodiments, the coil structures would be expected to receive a current of between about 100 μA and 100 mA and operating voltages between about 1 V and 50 V, and in response generate a magnetic field having an intensity equivalent to emulate magnetic card domains of between about 1000 and 10,000 oersteds.

While a variety of inductor and simulacrum structures may be employed by various embodiments in accordance with the present invention, these embodiments may share several common features. For example, ISO/IEC specification 7811 governs the architecture and operation of magnetic stripe cards and reader devices, including such parameters as the width of the card and positioning of the magnetic stripe. FIG. 4A shows an end view of such a slot of a magnetic stripe reader. Slot 8 has a total width “X” of between about 0.060″ and 0.090″. Magnetic reader head 10 may be biased by leaf spring 12 to project a distance of between about 0.000″ and 0.090″ into slot 8, but head 10 may be biased back into the reader housing by the sliding card to lie flush with the slot wall. Simulacrum 28 may occupy a thickness “Y” of up to about 0.040″ of slot 8, leaving gap 42 of distance “W” of approximately 0.050″ to accommodate magnetic stripe reader card 44 having a thickness of approximately 0.030-0.040″. In this manner, an adaptor in accordance with embodiments of the present invention would conform to the dictates of the ISO 7811 magnetic card standard, and the associated capabilities of typical magnetic card reader systems.

The differential inductor structure illustrated in the embodiment of FIG. 4 offers a number of advantages. One benefit is that core elements 40a-d are not physically connected: they are separate and distinct pieces. This offers the advantage of imposing a greater magnetic flux density in the magneto-inductive gaps 48a and 48b because of the ratio of coil windings area and the inductor core elements area, smaller space requirements due to the smaller coils on each inductor core element, and the ability to remotely locate the core with coil winding simply through the use of extended core elements that can be shaped and constructed into longer pieces. The coil windings on the inductor core elements are separate and distinct and may be electrically charged individually via each distinct trace. Alternatively, the coil windings may be electrically charged concurrently through serial connection of the coils in such manner as to develop a positive field on one core element gap, and a negative field on the other core element gap, thereby causing a differential induced field at the gap of the inductor core elements.

The embodiment of the ViVOadapter illustrated and described in connection with FIG. 4 shows a simulacrum utilizing a differential inductor structure designed to emulate a card having two magnetic stripe tracks. However, the present invention is not limited to this particular embodiment, and other structures for converting electrical signals into magnetic signals in a form recognizable to a magnetic reading head would also fall within the scope of the present invention. Also, more coils, inductor core elements, and electrical traces can be added in order to permit interfacing with magnetic card readers capable of reading cards having more than two tracks. Additionally, the use of high-plasticity ferroelectromagnetic elements is envisioned. These elements may be charged to create an electromagnetic field.

A benefit of the tape-based differential inductor simulacrum is its maximum thickness of 0.040″ and a typical thickness of 0.025″ allows the tape to remain in the magnetic card POS swipe/insert reader devices slot concurrent with accessibility of a standard IEC-ISO 7811 format card. This will not render invalid the POS reader device qualifications and specifications because no electrical connection or mechanical components will be altered in function. Additionally, the ease and rapidity of installation with the alignment guide will be advantageous for the technician, with lower associated skills required and risks of alignment or other installation errors. Another benefit of the design of the simulacrum inductor structure is that it can also be utilized to capture magnetic card data.

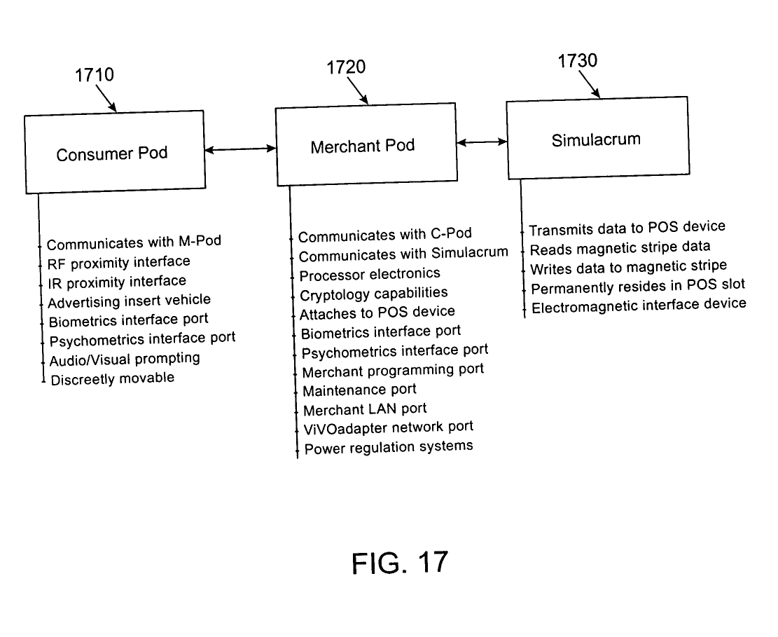

FIG. 17 is a simplified block diagram summarizing functionality of major components of an embodiment of an adaptor in accordance with the present invention. FIG. 17 depicts the ViVOadapter as an integration of three primary components: the Consumer Pod 1710, the Merchant Pod 1720, and the simulacrum 1730. Consumer Pod 1710 houses electronic components for RF and IR communications with the user and acts to transmit the related data to the Merchant Pod 1720 for transmission to the Simulacrum 1730. The Consumer Pod may be discreetly moveable for convenience of user interaction and provides a surface for advertising text and graphics visible to the user. The Consumer pod may also provide audio-visual indicia for prompting of the user during interaction. The Consumer Pod may also provide electronic interface components for such user-related peripherals as biometric and psychometric devices as finger-print and pin-pads. Additional input devices may include bar-code scanners and iridology devices as described herein.

The Merchant Pod 1720 may house the main electronic components associated with CPU and programming functions, and with interface components for the Consumer Pod, Simulacrum, and power regulation. The Merchant Pod may attach to the POS reader and utilize a cryptographical processor to provide secure data to the main microprocessor which communicates with the Simulacrum 1730 and C-Pod 1710. The Merchant Pod has a communications port which may be used for merchant preference programming and communications with the merchant's network, and ViVOadapter networks as described herein. The communications port may be used for biometric and psychometric devices such as finger-print analyzers and pin-pad for alpha-numeric user codes. Additional input devices may include bar-code scanners and iridology devices as described herein. Maintenance upgrades of firmware and software may be effected via the communications port either directly with another computer device or cellular/ wireless ISP transceiver, or remotely with the wired telecommunications system

The simulacrum 1730 may be substantially permanently installed within the POS magnetic card acceptance system card swipe slot and acts to produce a highly localized electromagnetic field, via magneto-inductive gap technology, for coupling with the POS magnetic reader head. The simulacrum is capable of transmitting data to multiple tracks on the POS reader head. In an alternate embodiment, the simulacrum is capable of reading magnetic card data and transmitting this data to the Merchant Pod. In still another alternate embodiment, the simulacrum is capable of writing data to the magnetic card stripe.

FIG. 5 is a simplified descriptive block diagram illustrating elements of the ViVOadapter and related system components. This systems diagram depicts an intelligent device with microprocessor 30, including firmware, software, ROM, RAM, and firmware/software control logic, a “smart chip” micro-controller with integrated cryptographic co-processor 32 conforming to the EMV (Europay/ Master Card/ Visa) security smart-card standards specifications and capable of generation of symmetrical and asymmetrical encryption keys and performing typical cryptographic analysis standard to “smart cards” and internet-based financial transaction browsers. Input-output devices include the RF ISO 14443 Type A/B and ISO 15693 proximity transceiver 22a, Bluetooth IEEE 802.11(b) or other RF protocol transceiver 22b, IrDA compatible infrared transceiver 22c, audio and visual cue/system status indicators 23, and the differential inductor simulacrum 28 that will emulate a dynamic magnetic stripe typical to credit/debit/ATM/pre-pay/loyalty/member/ID magnetic stripe cards.

The ViVOadapter microcontroller is merchant programmable through communication port 31b and has public key interface (PKI) and digital certificate software features for mutual device authentication, data integrity verification, and secure encryption communications with the user's PTD. Communication port 31b may also receive an electrical cable which enables direct communication with other devices, such as a laptop computer utilized to communicate with the adaptor to implement programming upgrades and other maintenance, communication with the merchant's systems and network to allow concurrent financial transaction and order processing among other capabilities, peripheral communications, and other devices described herein.

Controller 30 will also enable the merchant/user to select the preferred communications mediums that include RF 14443 type A and/or type B and RF 15693, IR, Bluetooth IEEE 802.11(b) or other RF protocol such as IEEE 802.11(a) or 802.11(g), and cellular/wireless ISP or wired providers, either discreetly or collectively. The controller will also accept unique merchant/user codes and relevant data associated with the merchant/user for identification and non-repudiation schemes. Wireless data transceiver 22d may be integrated for PTD-wireless network/ISP and PTD-ViVOadapter RF and Short Messaging Service (SMS) protocol communications for transactions beyond normal short range RF and infrared distances, or for mobile transactions. As described below in connection with FIG. 6, certain alternative embodiments may include integrated redundant magnetic swipe card reader 22e.

Only certain embodiments in accordance with the present invention are shown and described in the instant disclosure. One should understand that the present invention is capable of use in various other combinations and environments and is capable of changes and modifications within the scope of the inventive concept expressed herein.

For example, while the embodiment illustrated and described in connection with FIGS. 1-4 shows a simulacrum which is of sufficiently narrow dimensions to allow for the presence of a magnetic stripe card in the slot, this is not required by the present invention. In accordance with an alternative embodiment of the present invention, a ViVOadapter could include a separate, substitute magnetic card slot, magnetic reader head, and processor for receiving signals from the magnetic reader head by an IEC ISO 7811 conformal magnetic stripe card, and still remain within the scope of the present invention.

This approach is illustrated in FIG. 6, which shows a perspective view of an alternative embodiment of an adaptor for a magnetic stripe card reader in accordance with the present invention. Magnetic stripe reader adaptor 610 comprises simulacrum 72 that is similar in shape and function to that described above in connection with FIGS. 1-4, except that its width is not required to be sufficiently narrow to permit a magnetic stripe card to be inserted into the slot at the same time. Instead, alternative adaptor structure 610 features a separate magnetic stripe reader component 612 including slot 76 and magnetic head 78 in electromagnetic communication with slot 620 of conventional magnetic stripe card reader 600. Swiping of a magnetic stripe card in slot 76 across magneto-inductive head 78 creates a series of pulses. These signals are received by a processor and converted into a format recognizable by the second magnetic head of the existing POS device by the simulacrum as described in the primary embodiment. The adaptor 610 shown in FIG. 6 may include a separate C-Pod portion (not shown) that is in wired or wireless communication with the adaptor portion housing the simulacrum and the separate magnetic stripe reader component.

The alternative embodiment shown in FIG. 6 will be capable of capturing magnetic card data during the swipe process, storing it in temporary memory, and transmitting this data to the PTD or to the ViVOserver, or to a third party data repository via wireless or wired communication such as a network modem for DSL. The data can be encrypted and a decryption key transmitted to the PTD via the wireless carrier/ISP. The PTD user will retrieve the key upon satisfaction of a proper authentication process, for example one performed in conjunction with the ViVOwallet or another eWallet-type application.

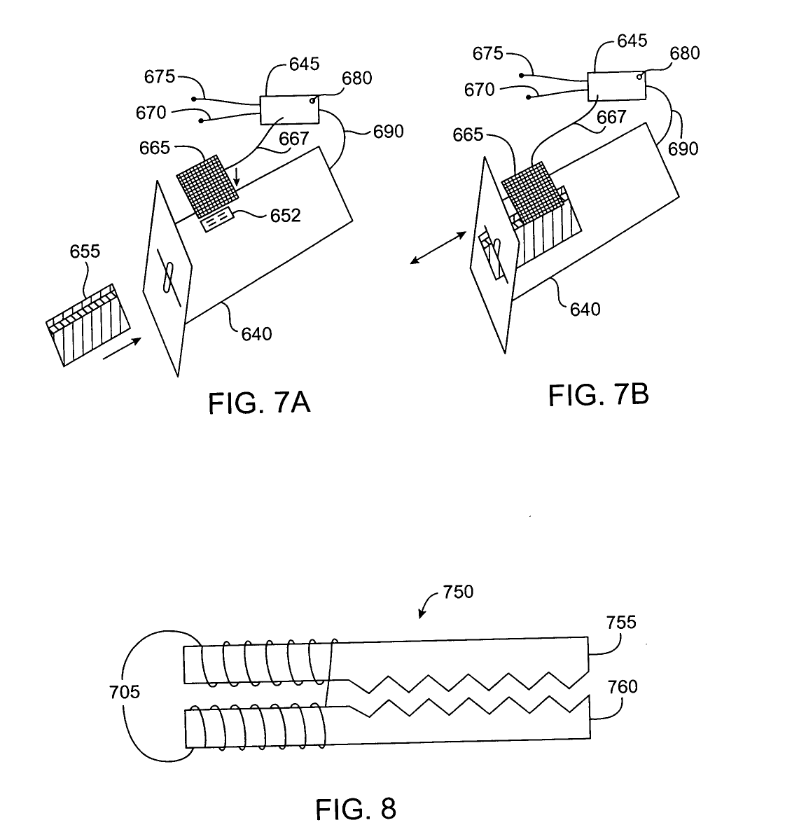

While the embodiment of the present invention described in FIGS. 1-4 is shown adapting to a POS magnetic card reader having an exposed slot, the present invention is not limited to this particular type of configuration. FIGS. 7A and 7B show simplified perspective views of the use of an adaptor in accordance with an embodiment of the present invention for use with a magnetic card POS card insert device 640 typically installed in a vending machine or ATM. ViVOadapter 645 including differential inductor simulacrum 665 is attached with cable 667 routed to the remotely located ViVOadapter case 645. The differential inductor simulacrum tape 665 is attached to the card reader device in such a manner to allow direct contact of the differential inductor simulacrum with the card reader magnetic head sensing component 652 while ensuring continued magnetic card insert functionality. Simulacrum 665 of ViVOadapter 645 is positioned proximate to an existing card swipe slot having a magnetic read head 652, until both units are in vertical and horizontal alignment. The magnetic card 655 is inserted into the slot and acts to lift the tape with differential inductor simulacrum 665 until the card is physically between the magnetic read head 652 and the differential inductor simulacrum 665 as shown in FIG. 7B. The visual indicators 670 and infrared transceiver components 675 can be integrated with the ViVOadapter case design 645, or may be remotely located and communicate with the simulacrum 665 through cables or wireless means. A bi-directional data port 680 is provided for interface with existing or future POS card systems and the ViVOadapter power cable 690 is attached to the POS device or system, or attached to a dedicated power supply.

A benefit of this design configuration is the ease and speed of deployment in the merchant POS card reader devices. Additionally, the POS card reader device will only have magneto-inductive coupling with the ViVOadapter and this will not compromise the qualification or security of the POS card reader device.

Another example of possible variation from the particular embodiment shown in FIGS. 1-4A is to vary the structure of the inductor core elements. For example, an alternate embodiment of an inductor structure for a simulacrum in accordance with the present invention is shown in FIG. 8. Inductor 750 comprises two core elements 755 and 760 bearing complimentary saw tooth shapes and encompassed by coils 705. The saw-tooth edge provides a horizontal magnetic domain field flux component via trigonometric function of the angle of the gap orientation. This will enable the simulacrum to be placed in the approximate, but not necessarily exact, position of the POS card system magnetic reader head component to effect a digital signal on the output leads. A benefit of the design of the differential inductor structure of the simulacrum shown in FIG. 8 is that it provides horizontally-oriented magnetic flux-field domains in a linear process over any length of distance, due to the trigonometric function of horizontal and vertical magnetic fields. This characteristic enhances alignment tolerance for the merchant or user installing the ViVOadapter into the slot of the magnetic stripe reader device, and accommodation of variations in dimensions and mechanical design for the various POS card swipe/insert systems to which the ViVOadapter is intended to fit.

As described so far, embodiments of adaptors in accordance with the present invention have functioned primarily to receive information from wireless devices such as RF proximity chip cards or personal trusted devices (PTDs) such as PTDs or cell phones, and to translate this information to a format recognizable by a conventional magnetic stripe card reader to effect a purchase or other type of electronic transaction. However, an adaptor structure in accordance with embodiments of the present invention is not limited to performing this particular function.

In one alternative embodiment, an adaptor structure in accordance with the present invention can be utilized to disable stolen or unauthorized magnetic stripe cards without the knowledge of the person attempting to use the card. Upon swiping of a stolen or unauthorized card, the magnetic stripe card reader would receive a signal denying the transaction and authorizing destruction of the card. This message could in turn be communicated to the ViVOadapter through the communication port. Upon receipt of the message authorizing destruction of the card, the ViVOadapter could be programmed to request that the prospective purchaser swipe his or her card again. Without the awareness of the prospective purchaser, during this second swipe of the card the ViVOadapter could cause the inductor to generate a electromagnetic field of sufficient intensity to alter the polarization of the magnetic stripe domains on the card. This technique would be sufficiently effective to disable the card for any future use, regardless of how much data, beyond a single bit, is written onto the magnetic stripe of the card, because of strict requirements of IATA and ABA industry standards regarding the integrity of card track data. Once the card is disabled in the manner described above, the transaction would be again refused, but without promoting any confrontation between the merchant and the prospective card user. In an alternative embodiment, disabling of the card may be based upon a signal received from a separate wireless transceiver in communication with a third party fraudulent or unauthorized card database, for example that found at http://www.cardcops.com.

### II. Secure Importation of Information

The above description has focused upon methods and apparatuses allowing emulation of non-magnetic stripe card information for reading by a conventional magnetic stripe card reader. Embodiments of the present invention allow confidential information, for example from a magnetic stripe card, to be imported into a PTD in a secure manner. The confidential information can then be used by the PTD owner to effect purchases using the techniques and system described above, or can be used in conjunction with other networks and/or infrastructure designed to allow PTD's to effect purchases.

As a threshold matter, it is noted that for purposes of this patent application the term “encryption” refers to imparting a single, discrete layer of security to information imported into a PTD. Information that is encrypted/decrypted according to the present invention may already be in encrypted format based upon one or more previously-imposed additional security procedures that are outside the scope of the instant patent application. Thus upon decryption of imported information in accordance with embodiments of the present invention, such already-encrypted information may not be immediately available to the PTD user, but may require further decryption processes. For example, the code read from a magnetic stripe card may be in encrypted form even before it is encrypted for PTD importation according to embodiments of the present invention.

FIG. 23 shows a simplified block diagram that schematically illustrates a method for securely importing information into a PTD in accordance with the present invention. User 2300 is in possession of PTD 2302, for example a portable phone having a processor, a memory, a short range infrared transceiver, and a long range cellular wireless transceiver. Confidential information 2303 from source 2304 such as credit card account information from a credit card issuer, is sought to be imported into PTD 2302 in a secure manner.

Accordingly, information 2303 encrypted at source 2304 is communicated in encrypted form along first communication channel 2306 to PTD 2302. In the specific embodiment shown in FIG. 23, first communication channel 2306 comprises an electronic communication channel, for example a wired or wireless data network connections implemented through short or long range media such as infrared, proximity RF, or cellular telephony.

The encrypted imported information is then stored in a memory of the PTD 2302. This imported information is present on the PTD, but in encrypted form precluding its availability for transactional use.

A decryption key 2308 corresponding to the encrypted information is generated at source 2304. This decryption key 2308 then communicated to user 2300 along second communication channel 2310 that is different from first communication channel 2306. In the particular embodiment shown in FIG. 23, second communication channel 2310 comprises a postage channel connecting source 2304 with the PTD user's home 2312. Because the decryption key 2308 is being forwarded to user 2300 through a separate and independent channel of communication, source 2304 may be confident that a non-authorized entity will not be able to access both the information 2303 and the decryption key 2308, thereby establishing a strong non-repudiation scheme.

Once the user has obtained the decryption key through the second communication channel, this key may be entered into the PTD to decrypt the imported information and render it available for transactional use, for example the purchase of goods or services utilizing the PTD and FDA software application hosted thereon. For purposes of the instant patent application, a user's act of manually entering into the PTD a decryption key received through a second communication channel (i.e. postal mail), is considered communication of the decryption key through that second channel.

The data importation process summarized in the simplified diagram of FIG. 23 may include additional steps. For example, in certain embodiments the encrypted information may comprise credit card account information, such as for a new card to be activated by the user of the PTD. Upon successful decryption of the new credit card account information, the FDA software may direct the PTD to send a message notifying the credit card issuer of activation of the card, removing any remaining barriers to its use. Such a procedure would obviate the conventional activation process that typically requires the user to first call a telephone contact center in order to active a new credit card account.

The specific information importation method shown and described in connection with FIG. 23 relates to an embodiment wherein the decryption key is forwarded to the PTD user through separate communication channel comprising postal delivery. However, this is not required by the present invention.

In accordance with an alternative embodiment of the present invention, the decryption key could be forwarded to the user of a PTD through another type of separate communication channel. For example, a server administered by the information may host a secure web site accessible by the user only upon entry of certain confidential parametric information. Once accepted within the website, the decryption key could be communicated to the PTD user as an email or other type of electronic message.

And while the specific information importation method shown and described in connection with FIG. 23 relates to an embodiment wherein the financial information is encrypted at its original source, for example at the issuer of a credit card, this is also not required by the present invention.

In accordance with an alternative embodiment of the present invention, information could be encrypted and then communicated to a PTD from an intermediate source, for example a third party having authorization from a ultimate source such as a bank or credit card issuer. Such a third party could act as an intermediary, administering a server responsible for encrypting and then directing the encrypted information to a particular user. An example of such an approach is described below in connection with the ViVOserver.

In accordance with still another alternative embodiment of the present invention, an adaptor/interface device located at a merchant or other remote location could function as an information source, allowing relevant nonencrypted information from a conventional plastic magnetic stripe card, a second PTD, or some other source, to be encrypted, imported into a PTD, and then decrypted for transactional use. In one embodiment, information read from the magnetic stripe card by a magnetic head could be encrypted and then communicated in encrypted form to the PTD though a transceiver described herein, such as an IR or RF transceiver.

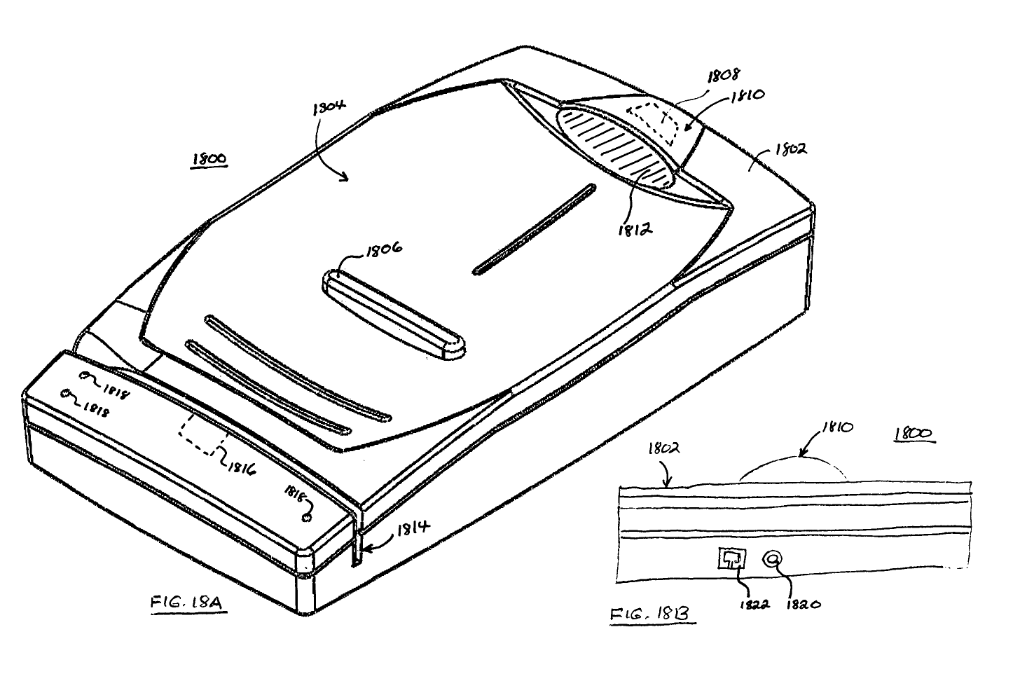

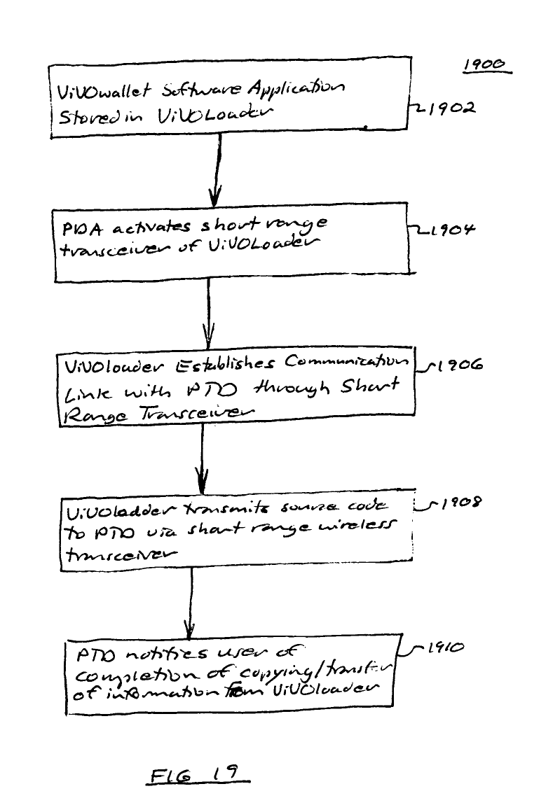

FIG. 18A shows a perspective view of an embodiment of an adaptor structure in accordance with the present invention, which is configured to import information into a PTD in a secure manner. An adaptor configured for this purpose is also referred to herein as a “ViVOloader™”.

ViVOloader™ 1800 comprises upper surface 1802 including indentation 1804 that is sized and shaped to receive a PTD such as a cell phone. Upper surface 1802 further bears gravity-activated bar 1806 positioned at the bottom of indentation 1804. Short range wireless transceiver 1808 such as an IR transceiver, is positioned within projection 1810 of upper surface 1802, and is capable of communication through adjacent window 1812. Adaptor 1800 further defines magnetic stripe card slot 1814 and magnetic reader head 1816 in magnetic communication with slot 1814. Indicator lamps 1818 positioned on upper surface 1802 may indicate the status of the adaptor 1800.

One function of the ViVOloader™ adaptor device 1800 shown in FIGS. 18A-B is to allow financial or other confidential or nonpublic information to be imported in a secure manner into a user's PTD from an outside source. The imported information can then usefully interact with one or more software applications resident on the user's PTD. One specific example of such a software application is the ViVOwallet financial management software discussed below, and also discussed in detail in co-pending U.S. nonprovisional patent application Ser. No. 10/___,___, (Atty. Docket No. 021633-000810US), filed April___, 2003 and incorporated by reference herein for all purposes.

FIG. 18B shows a rear view of the ViVOloader™ 1800 shown in FIG. 18A. ViVOloader™ 1800 further comprises a first input port 1820 for receiving power, and a communications port 1822 such as a serial port, allowing for active communication with a wired network. The internal structure of the ViVOloader™ shown in FIG. 18A-B may be represented by the block diagram of FIG. 5, including a cryptoprocessor and a memory. While the ViVOloader™ shown in FIGS. 18A-B does include a separate magnetic stripe card reader, it may not include the simulacrum structure. This is because the ViVOloader™ may operate as a stand-alone interface, rather than serving as an adaptor for an existing device.

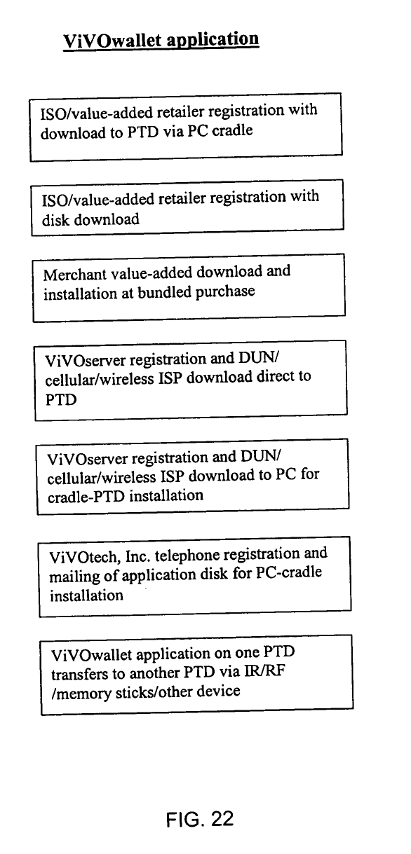

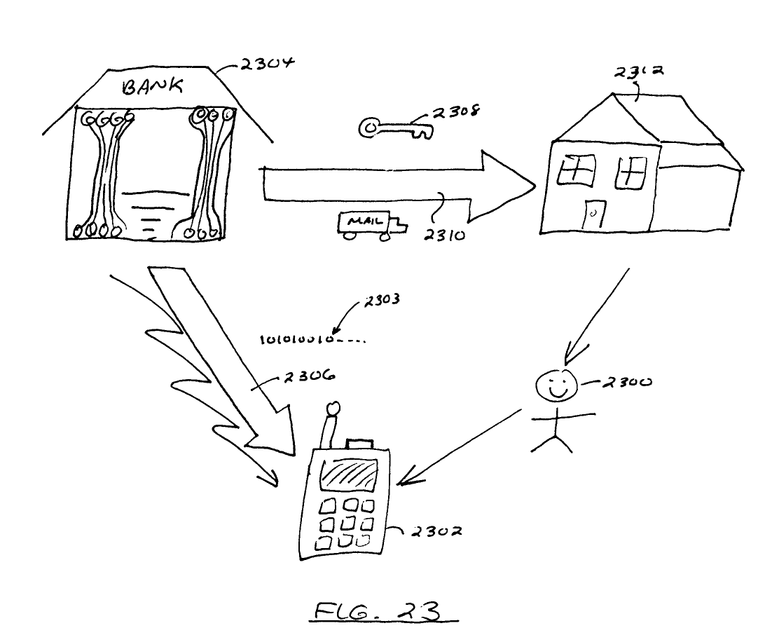

In many cases, a user may already have the financial data aggregation software application loaded and available for use by his or her PTD. FIG. 22 identifies various ways by which a financial data aggregation (FDA) software application such as the ViVOWallet can be provided to a user's PTD. FIG. 22 shows that the FDA can be downloaded to the PTD from a source that is physically transported to the ViVOloader, for example via a PC cradle, disk module, memory module, or CD-ROM storage media. Other approaches include loading the FDA utilizing Merchant IR or RF kiosk, Merchant or POS system adapter with application in resident memory, via a Merchant or ISO network server, direct from a server through a cellular/wireless ISP network or API portal, via the User's PC, or via PTD-PTD transfers with such mediums as IR and memory module.

Where the software application has not yet been loaded into the user's PTD, the first step in utilizing the ViVOloader™ device is to import the software application into the PTD. FIG. 19 shows a simplified flow chart illustrating process steps for loading the ViVOwallet software application into a user's PTD utilizing the ViVOloader device. In a first step 1902 of software loading process 1900, the ViVOwallet application has already been transferred into the memory of the ViVOloader.

In accordance with one embodiment, the ViVOloader™ may be in communication with a source of the ViVOwallet program through a wired network connection utilizing the communication port. In accordance with another embodiment, the ViVOloader™ may be in communication with a source of the ViVOwallet program through a wireless network connection, such as may be provided by a long-range RF wireless transceiver present in the ViVOloader™. In accordance with yet another embodiment, the ViVOloader™ may be in communication with a source of the ViVOwallet program from a second PTD or portable device brought into contact with the ViVOloader™ and which communicates with the memory of the ViVOloader™ through the wired communication port or in a wireless manner through the short range wireless transceiver.

In a second step 1904 of FIG. 19, the user's PTD is placed within the indentation upon the gravity bar, thereby activating the short range wireless transceiver of the ViVOloader™. While activation of wireless transceiver of the specific device may occur through gravity, the present invention is not limited to this particular means of activation. In accordance with alternative embodiments the short-range transceiver of the ViVOloader™ could also be configured in an auto-detect mode, or be activated by some other triggering event, including but not limited to interruption of a continuous light beam by placement of a PTD within the indentation. In still other embodiments, the short range transceiver of the ViVOloader™ may be activated by manual operation of a switch present on the ViVOloader™ itself, for example where the PTD exhibits a shape or size that prevents automatic activation.

In third step 1906 of FIG. 19, the ViVOloader™ establishes a communication link with the PTD through the short range wireless medium, including but not limited to infrared, or radio frequency. In fourth step 1908 of FIG. 19, the ViVOloader™ transmits the source code for the ViVOwallet application to the PTD via the short range wireless medium.

In final step 1910 of FIG. 19, at the completion of transmission of the entire ViVOwallet application source code to the PTD, the ViVOloader™ may provide a visual and/or audio indication. For example, the upper surface of the embodiment of the ViVOloader™ shown in FIG. 18A includes an indicator light for this purpose.

Once the source code of the ViVOwallet software application has been copied or transferred to the memory of the PTD from the memory of the ViVOloader™, the PTD may notify the user and request permission to install the ViVOwallet software application. The PTD may also request that the user create an application level password. A ViVOwallet application icon may then be added to the program group of the PTD.

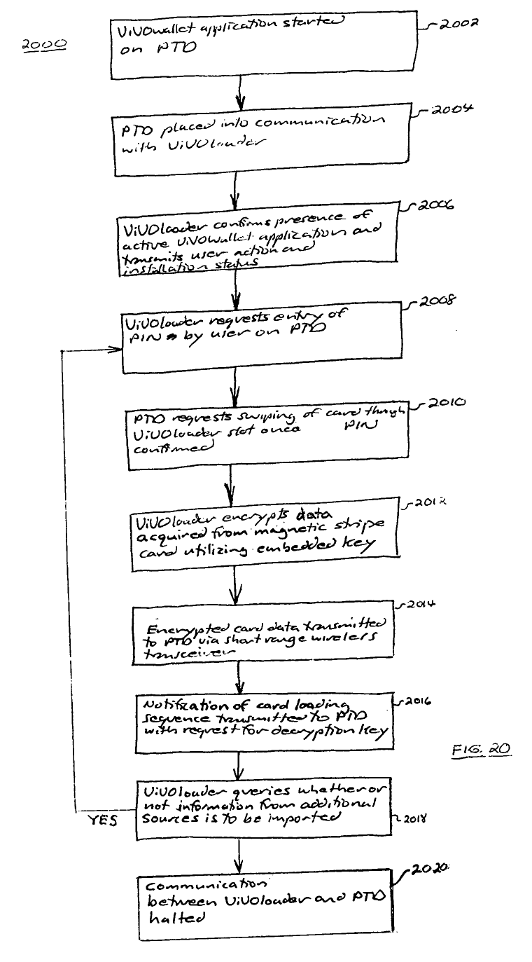

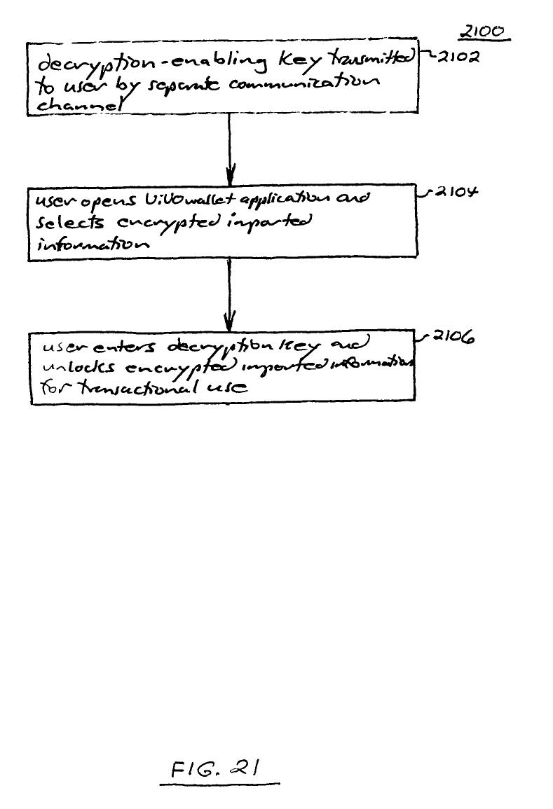

Once the ViVOwallet software application has been installed onto the user's PTD, the user is then able to import financial or other information into the PTD from outside sources utilizing the ViVOloader™. FIG. 20 shows a simplified flow chart illustrating process steps of importing information from a magnetic stripe-type card into a user's PTD utilizing the ViVOloader™ device.

In first step 2002 of the importation process 2000 shown in FIG. 20, the user starts the ViVOwallet application on the PTD. In second step 2004, the user places the PTD into communication with the ViVOloader™ device, for example by actuation of gravity bar or through activation of an auto-detect sensor. Alternatively, the user may also activate the PTD ViVOwallet application and aim the short range communications transceiver of the PTD at the ViVOloader™.

In the next step 2006, the ViVOloader™ will confirm the presence of the active ViVOwallet application on the PTD, and transmit user action and installation status requests in text on the user's PTD screen.

In step 2008, the ViVOloader™ requests from the user, via the screen of the PTD, entry of a personal identification number (PIN) associated with the specific card for security purposes. This PIN number is one that is created by the user, and should not be confused with other security codes, for example a PIN number assigned to each card by the issuer of a credit card to provide security for cash withdrawals from debit cards or cash advances from a credit cards. The request by the ViVOloader™ for the user-generated PIN is made at the beginning of each card importation cycle, and will be repeated for each cycle until the user halts the process.

In accordance with one embodiment of the present invention, the user-generated PIN may be unique to each source of information that is to be imported, thereby providing security at the card level. In alternative embodiments, the user may generate the same PIN for all imported information, thereby providing security at the PDA level. The minimum and maximum key size for the first PIN will be defined by the PTD-loaded software according to the dictates of the application author or a financial institution, and would typically be between about four and eight numerical characters in length. Where the user's PTD includes a keypad, the first PIN may comprise alpha, numeric, or combination of alpha-numeric keys. Where the user's PTD is a cell phone, the numeric keypad will have associated alpha characters and, therefore, the key can also be considered an alpha-numeric key on the key entry side.

In step 2010 of FIG. 20, once the user-generated PIN has been input by the user and accepted by the ViVOloader™, the PTD will then request that the user swipe their magnetic stripe card through the slot in the ViVOloader™ within a certain period of time for security purposes, typically 30 seconds or less. This delay may be hardware-implemented, (i.e. by capacitive delay) or software-implemented (i.e. by a time-out feature).

The indicator lamp of the ViVOloader™ may then indicate whether the magnetic stripe card has been swiped correctly, with the proper speed, direction, and card orientation. The ViVOloader™ will also confirm integrity of data received from the magnetic stripe card using techniques including but not limited to cyclic or linear redundancy checks of card data bits. The ViVOloader™ may also automatically identify the card type and/or card issuer according to the card number scheme and/or other criteria promulgated by the issuer or a standards body.

As described above, the ViVOloader™ includes a cryptography chip storing one or more encryption routines. Therefore, in step 2012 the ViVOloader™ encrypts the card data with an embedded key(s). This encryption may conform to industry standards that may include EMV specifications. Due to the encryption step 2012, information copied from the source (i.e. the magnetic card) is secure and not available for interception or misappropriation. Examples of encrypted card data may include, but are not limited to, one of account number, expiration date, affiliated bonus/loyalty program identifiers, the name and social security number of the account holder, and the crime victim compensation commission (CVCC) code for the credit card.

In step 2014, the encrypted card data is transmitted from the to the ViVOloader™ to the PTD via the short range wireless communications medium. Once the imported encrypted information is received by the PTD, an icon may be transmitted with the encrypted card data and appear along with some obvious indicator, for example gray scale or shadowed display, that the associated card data has been installed into the PTD but has not yet been decrypted and is accordingly not yet transaction-ready.

In the next step 2016, the ViVOloader™ transmits a conclusion of the card loading sequence to the PTD screen, and then advise that the ViVOwallet application is awaiting user entry of a specific single-use decryption key for the imported information so that it can be utilized. This information imported from the swiped magnetic stripe card thus remains inaccessible for transactional use, as may be indicated by the manner of icon display.

In the following step 2018, the ViVOloader™ will query, via the PTD screen, whether or not the user wishes to utilize the ViVOloader™ to import information from additional sources into the PTD. If the user desires to import information from additional sources, the user returns to previous step 2008 to begin another sequence of steps 2008-2018.

Where information from all sources for the current session has been imported into the PTD using the ViVOloader™, in step 2020 the communication link between the ViVOloader™ and the PTD is terminated. The card or other loaded data stored in the ViVOloader™ is destroyed, with the relevant card information remaining only on the PTD in encrypted form. Alternatively, the card data stored on the ViVOloader™ may be destroyed at the end of each import sequence loop (i.e. after step 2016 of FIG. 20), before querying whether information from additional sources is to be imported.

Recapping, at the conclusion of step 2018 of the information importation process summarized in FIG. 20, relevant source information has been imported onto the user's PTD, but remains encrypted and unavailable to the user for transactional use. FIG. 21 accordingly presents a simplified flow chart illustrating steps of decrypting magnetic stripe card information imported into a PTD utilizing the ViVOloader™ adaptor device.

In a first step 2102 of process 2100, a key enabling decryption of the imported data is transmitted to the user through a user verification process. In certain embodiments, this decryption key is communicated to the user through a channel separate from that utilized to communicate the encrypted information to the PTD.

One example of such a separate channel for communicating the decryption key is the postal system. In one specific embodiment, the decryption key could simply be mailed to the home address of the PTD user. In an alternative embodiment, the decryption key could be provided in a mailed financial statement related to the imported information, for example as a line item under the merchant name of ViVOtech, Inc. in the monthly billing statement for a credit card that is to be imported. Utilizing such an approach, a dollar line item of $23.11 to ViVOtech, Inc. in the monthly billing statement would indicate a decryption key of “2311”, with the amount charged by ViVOtech, Inc. automatically credited back for a net balance of zero dollars.

Another approach for communicating the encryption key requires the PTD user to telephone a contact center administered by ViVOtech or a financial institution. Much in the same manner as with conventional credit card transactions, in this approach the decryption key could be provided upon proper authentication of the user's identity, for example by requiring the user to provide his or her mother's maiden name.

Still another approach for communicating the decryption key to the PTD user utilizes a wired or wireless network connection to email the key to the user's PDA utilizing the website of the card issuer. Another alternative approach would be to transmit the decryption key to the user via the ViVOServer utilizing a secure socket layer (SSL) connection in conjunction with the web-based ViVOwallet or other software application. Still other approaches for communicating the decryption key would be through a short messaging service (SMS) or web browser established with the PTD user, or through a secure faxing protocol.

In second step 2104 of the process shown in FIG. 21, the user opens the ViVOwallet application on the PTD and selects the specific icon representing the imported encrypted information. In third step 2106, the user enters the appropriate encryption key when prompted by the ViVOwallet program. At the conclusion of step 2106, the information imported into the PTD is no longer “locked”, and this changed status may be reflected by a change in the display of the associated icon, for example display in color or non-shadowed format. In certain embodiments, the icon associated with a particular source may be designed by the issuer of the information source, i.e. an icon representing information imported from a Visa card may duplicate the Visa logo. Alternatively, the icon may be designed by the author of the ViVOwallet or other software application run by the PTD.

In step 2106, the user may next utilize the imported data in a transaction at any time by selecting the icon and entering the same PIN originally generated by the user at the beginning of the importation process summarized in FIG. 20.

Importation of encrypted information to a PTD, and subsequent decrypting of the imported information utilizing a decryption key provided to the user through a separate channel, has been discussed above in connection with FIGS. 20-21 primarily in conjunction with utilization of a ViVOloader interface device. However, embodiments in accordance with the present invention are not limited to decryption of information imported into a PTD through an interface device.

In accordance with alternative embodiments of the present invention, encrypted private information may be imported into a PTD directly from a source other than the ViVOloader or other interface device. The imported encrypted information could then be decrypted utilizing a key provided to the PTD user through another channel, for example the postal, telephonic, or electronic channels previously described. The PTD could import the encrypted information from a variety of sources, for example electronically through a SSL connection with a website of an entity providing the information in encrypted format. Still further alternatively, the encrypted information could be provided to the user's PTD through other mechanisms, including a wireless communication channel utilizing a long-range transceiver of the PTD.

While the specific information importation method previously shown and described focuses upon the use of different communication channels to convey the encrypted information and the decryption key, the present invention is not limited to this particular approach. In accordance with an alternative embodiment of the present invention, the imported information and the decryption key could be communicated to the PTD user utilizing different devices, and the method would remain within the scope of the instant application.

For example, in accordance with one alternative embodiment of the present invention, encrypted information for importation could be communicated to the PTD from an interface device utilizing a short range IR communications channel. The decryption key could also be communicated to the PTD through the same short range IR communications channel, but from a different device such as a personal computer of the PTD user. Such communication of the encrypted information and decryption key to separate devices would also serve to establish the desired strong non-repudiation scheme.

While the above discussion has focused upon importing financial information from a credit card into a PTD, embodiments in accordance with the present invention are not limited to this particular application. For example, alternative embodiments in accordance with the present invention may allow for secure importation into a PTD of information from a variety of sources, including but not limited to user identification cards, debit cards, automatic teller machine (ATM) cards, and customer loyalty cards. Moreover, information imported into the PTD in a secure manner need not necessarily be financial in nature, and alternatively could relate to other forms of information, for example the security clearance status of a particular individual.

Embodiments in accordance with the present invention are suited for importing information into a PTD in a variety of applications. For example, in certain embodiments the PTD may comprise an RF proximity smart card lacking a keyboard or display, conforming, for example, to ISO 14443 type A or B standard or to the ISO 15693 standard. This RF proximity smart card may have use limited to a particular locale or environment, for example a university or business campus, a resort, a cruise ship, or a casino. Upon entry into the environment, the user is issued the RF proximity chip card for use in a number of ways, including but not limited to gaining access to specific physical locations, paying for meals, activities, or amenities (i.e. carnival-type rides, spas) or making wagers or bets utilizing an accumulated cash balance. Once use of the card has diminished its available balance, the user may seek to replenish the available balance of the card by importing money from a source such as a conventional credit card.

In an application where the PTD comprises an RF proximity chip card lacking a display or input device (i.e. keyboard), the ViVOloader™ may include a keypad and text display in to allow user interaction. The ViVOloader™ may include a printer. In still other approaches, the ViVOloader™ may be utilized to indicate the status of the RF Proximity card having an embedded ViVOwallet software application. In such a manner, the ViVOloader™ will be capable of displaying the card status and any requested user actions, allowing the RF proximity chip card to passively accept imported data in a process transparent to the user.

In still other alternative embodiments, the PTD may take the form of an RF proximity chip card issued by a third party financial institution, for example a “smart” credit card. In such an embodiment, the user would be able to import information from the card utilizing the ViVOloader™, with knowledge and approval of the card issuer.

While the specific embodiment of the ViVOloader™ device shown in FIG. 18B includes a wired communications port, this is not required by the present invention. As stated previously, the internal configuration of the ViVOloader™ may be represented by the block diagram of FIG. 5, which includes a wireless network data transceiver. This transceiver could be utilized to allow the ViVOloader™ to operate as a remote portal, communicating with a network via a wireless, rather than wired, connection. Either or both of a wired or wireless network connection could be utilized to allow a card issuer to provide transaction authorization and/or to monitor the activity of imported information.

In accordance with an alternative embodiment, reading of information from the magnetic stripe card could result in the ViVOadaptor communicating with a remote data repository to obtain authorization for transmission of the magnetic stripe card data to the PTD. Upon receipt of such authorization from the remote data repository, the Adaptor could communicate the credit card data to the PTD directly, or communicate the data indirectly by providing to the PTD a key allowing decryption of a separate message containing the credit card information. This separate message could be transmitted through a wired or wireless network to the PTD directly, or indirectly via the ViVOloader™.

While the particular embodiment of the ViVOloader™ device shown and described in connection with FIGS. 18A-B includes a separate magnetic stripe card reader rather than a simulacrum, this is not required by the present invention. Alternative embodiments could feature a simulacrum, with the simulacrum inductor components capable of reading data directly from a magnetic stripe card in a similar manner to the magneto-inductive reader heads of conventional POS devices. The data read could be stored in the adaptor and then transmitted in a secure manner to any authenticated PTD with installed eWallet software capable of communication with the ViVOadaptor and authorized by ViVOtech, Inc.

In accordance with another possible alternative application, an adapter or interface device in accordance with the present invention may be used to facilitate the communication of data to a personal trusted device from a source such as another personal trusted device. In one embodiment, the adaptor would receive data at its wireless interface from one authenticated source, store the received data, and then transmit the data to an authenticated PTD. The data transmitted would not be limited to financial information and could include a financial management software application, thereby allowing a PTD not already containing the software to install the software and utilize the information from the first PTD without delay. Moreover, additional security could be imparted to the information transfer by causing the information to be encrypted by the adapter prior to transmission to the PTD. In such an application, the PTD would receive a decryption key in a separate message before the transferred data could be accessed.

Moreover, the source of the data communicated to the PTD need not be a second PTD, and could be a merchant network and supporting system interfaced with the communications port of a ViVOadapter. Communication with such a merchant network may enable transfer of information such as merchant coupons and loyalty program data to the PTD/RF proximity chip card at the point of sale, or anywhere a ViVOadapter is placed within a merchant's place of business. Multiple ViVOadapters with wired or wireless cellular ISP transceivers may be used as transponders relaying information to the user and to the merchant. Such information may be used for profiling of user purchasing habits and processes, and merchant promotion of coupons, gift certificates, and other instruments to the user's PTD. In still other embodiments, ViVOadapter can be used to communicate a financial management application directly at the POS, thereby enabling a PTD lacking the financial management application to ultimately communicate with a ViVOadapter.

### III. Adaptor Hardware and Software

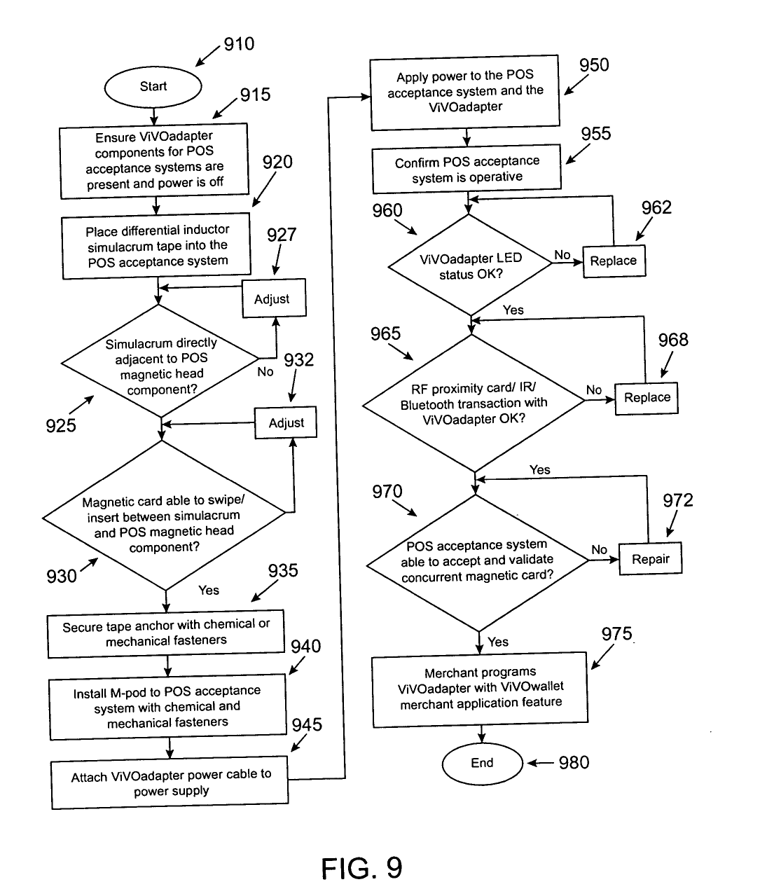

FIG. 9 is logical diagram of the installation of a typical ViVOadapter device in the POS systems. The technician will ensure all ViVOadapter components and tools are available 910, 915 and will place the differential inductor simulacrum tape into the POS system 920, so that the simulacrum is directly in contact with the POS systems magnetic head component 925, with any necessary adjustment as defined by the alignment guide attached to the simulacrum 927. The technician will confirm that normal magnetic stripe cards are able to be swiped or inserted into the magnetic head component slot 930 with any necessary adjustment of the alignment guide 932, and will then secure the differential inductor simulacrum tape 935 anchor with chemical/glue or mechanical fasteners included with the installation kit. The technician will install the ViVOadapter M-pod to the POS system 940 and secure with chemical/glue or mechanical fasteners included with the installation kit and then attach the power cable 945 to the POS system, or to a dedicated power supply. The technician will then apply power 950 to the POS system and ViVOadapter with confirmation that the POS reader or machine is operative 955. The technician will then confirm the ViVOadapter status indicators are normal 960 and replace 962 the ViVOadapter if this test is failed. The technician will then confirm an RF proximity chip card/IR/Bluetooth IEEE 802.11(b)/ SMS/ PTD-to-ViVOadapter and wireless network/ISP transaction as specified in the merchant/user programming, is effected 965. The ViVOadapter will be replaced if this test is failed 968. The technician will then confirm the POS system is fully functional and compliant for concurrent reading of magnetic cards 970 and will replace the ViVOadapter if functionality and compliancy are not met 972. Lastly, the merchant will use the ViVOwallet application merchant feature to effect programming 975 of merchant related data for completion of the installation process 980. The ViVOadapter will expect to receive a ViVOtech, Inc. specific authorized code such as “Hello ViVOwallet”, to ensure compliance of third party vendors.

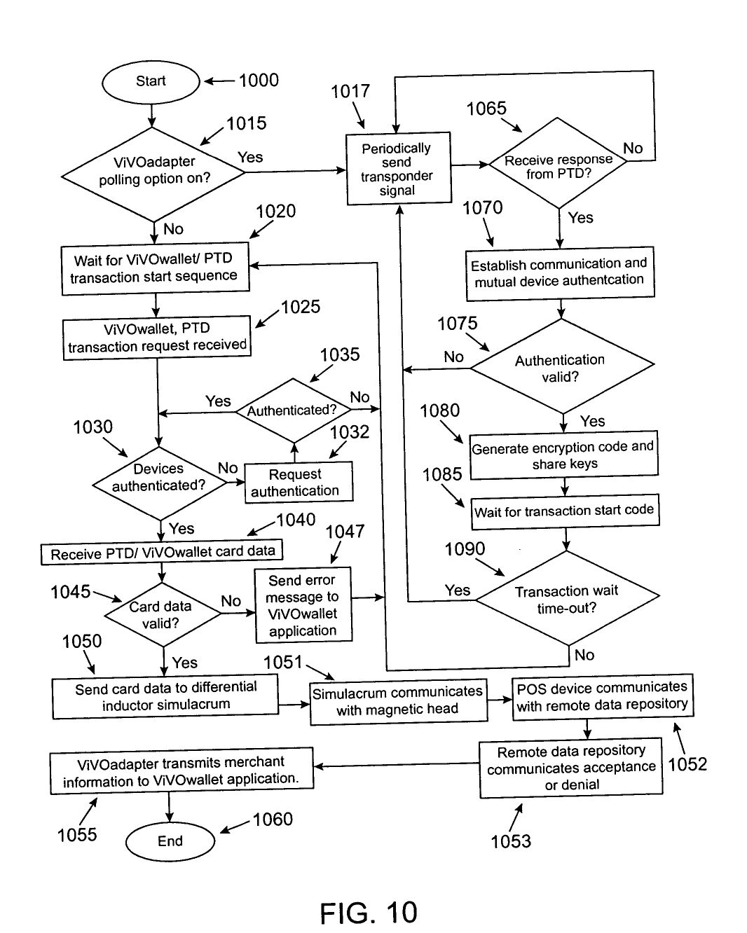

FIG. 10 is a logical diagram of the interface processes between the ViVOadapter and the PTD electronic wallet application, ViVOwallet pay-and-go™ feature application discussed below, and the. RF embedded ViVOwallet application transparent transaction process. The ViVOadapter will be operational 1000 and with the polling feature activated 1015. The ViVOadapter will transmit a transponder signal according to the merchant/user programming preferences that include RF ISO 14443 Type A or Type B and RF 15693, IR type IrDA version 1.2 or higher and ViVOTech Inc. proprietary and Consumer IR, IEEE 802.11(a)(b) or (g), and cellular/wireless ISP and wired protocols and wait for a response 1020. The ViVOadapter will perform mutual device authentication and challenge protocols, exchange security cryptography routines and keys, exchange data typical to credit/debit/ATM/pre-pay/loyalty/member/ID cards magnetic domain track data upon presentation by an RF proximity chip card or via other communication mediums described herein. Additionally, a unique RF proximity chip card or ViVOwallet identification information issued by the manufacturer, card issuer, acquirer, authorizer, and/or ViVOtech Inc. company authorized parties will be transmitted and authenticated.

The ViVOadapter will transmit a transponder signal via RF proximity 14443 type A or Type B and RF 15693/ Irda and Consumer IR/ IEEE 802.11/ cellular wireless ISP and wired provider protocols per merchant preferences on a periodic frequency 1017 until it receives a response from a PTD 25, whereupon it will establish communications and mutual device authentication 1030. When mutual authentication is validated 1030, 1032, 1035, the ViVOadapter will generate initial encryption codes and exchange security routines with the PTD, and exchange security certificates and wait for the ViVOwallet card data or the RF proximity chip card transaction initiation 1040. The ViVOadapter will wait for a period of time prior to time-out, or if card data is not valid 1047 with reset to the transponder state ViVOwallet/RF transaction start sequence state 1020. In the event the ViVOwallet application is active, the ViVOadapter will then wait for the ViVOwallet transaction start sequence code 1065. The ViVOwallet application will acknowledge the ViVOadapter transaction request code and confirm the ViVOwallet application with a unique ViVOtech Inc. identifier such as “Hello ViVOwallet” 1065, and the ViVOadapter are mutually authenticated 1070 within a specified period of time and if not, will then request re-authentication protocol procedures 1075. The mutually authenticated devices will initiate security encryption procedures and generate encryption codes and exchange cipher keys 1080. Once mutual authentication protocols are confirmed and the ViVOadapter is awaiting transaction start codes 1085, the ViVOwallet application or RF proximity chip card will transmit user-specific magnetic card data until transaction time-out period 1090. The ViVOadapter will confirm the card data is valid 1045 via cyclic redundancy check (CRC), linear redundancy check (LRC), or similar method of data integrity verification. If the ViVOadapter is unable to confirm card data validity within a specified number of attempts, then an error message 1047 will be transmitted to the ViVOwallet application and the transaction process will be terminated.

If the card data is validated, then the ViVOadapter will transmit the digital data to the differential inductor simulacrum 1050, which will then communicate the information to the magnetic head component of the POS card reader device 1051. The POS device will in turn transmit the card data to a remote data repository storing card validity information 1052, as is known in the art. The remote data repository will in turn communicate back to the POS device a transaction acceptance or denial signal 1053 based upon card validity information stored in the remote data repository, as is also known in the art. Where a transaction is authorized, the ViVOadapter will then transmit merchant-specific code information 1055 to the ViVOwallet application, with transmission confirmation request, and the transaction will be terminated 1060.

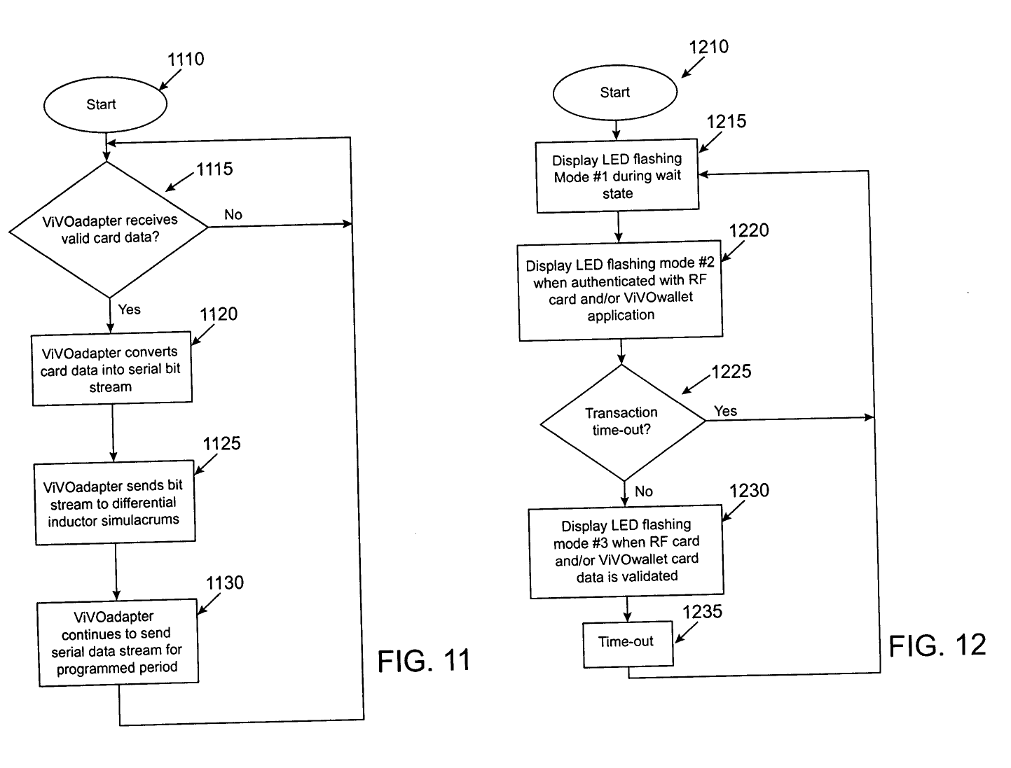

FIG. 11 is a logical diagram of the interface process between the ViVOadapter and POS swipe/insert card acceptance systems via the differential inductor simulacrum 1110. The ViVOadapter should complete the requisite processes described herein and the RF proximity chip card and/or ViVOwallet application card data must be valid 1115. The ViVOadapter will convert the card data into a digital serial data bit stream 1120 for transmission to the differential inductor simulacrum magneto-inductive gaps 1125 in a repetitive and cyclic process until a specified period of time has elapsed 1130.

FIG. 12 is a logical diagram of the user interface visual cue process 1210 to enable the user to determine the length of time to orient their PTD towards the ViVOadapter. The ViVOadapter will display a continuous blinking visual cueing indication/transponder signal with specified periodicity during the waiting state 1215. The ViVOadapter will then increase the periodicity or sequencing of one or more visual indicator(s) when authenticated with a ViVOwallet application or RF proximity chip card 1220. If the ViVOwallet application or RF proximity chip card fails to exchange transaction data within a specified period of time after authentication 1225, then the visual and/or audio cuing indicator(s) will sequence to the wait state 1215. If the ViVOwallet or RF proximity chip card exchanges valid card data during the transaction, then the visual and/or audio cueing indicator may increase in periodicity and indicators or sound to indicate the transaction is completed 1230 and the user is no longer required to maintain RF, IR, or Bluetooth IEEE 802.11(b) communication. The ViVOadapter will time-out within a specified period 1235 and sequence to the transponder wait state 1210.

### IV. Use of Adaptor in Conjunction with Other Systems

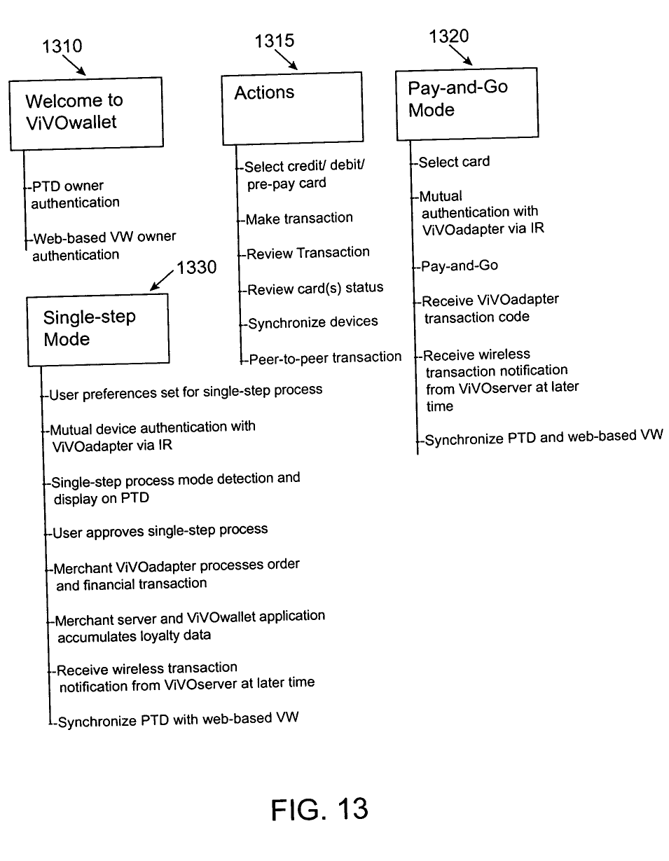

FIG. 13 shows a simplified descriptive diagram of the ViVOwallet™ financial data aggregation (FDA) software application. The ViVOwallet application aggregates personal financial information and personal credit/debit/ATM/pre-pay/loyalty/member/ID card information found on Track #1 and/or Track #2, or additional tracks, of the magnetic stripe of such cards and described by the International Air Transport Association (IATA) and the American Banking Association (ABA) and proprietary groups with encoded magnetic domain bit patterns defined upon the magnetic stripe described by the ISO/IEC 7811 magnetic card conformal specification. These electronic wallet (eWallets) financial management applications represent aspects of one application of embodiments in accordance with the present invention, i.e. the usage of cell phones, PTD, and other varieties of personal trusted devices (PTDs) with the ViVOadapter. The ViVOwallet application also provides software means to communicate with the network based databases, the pay-and-go feature described herein, and the ViVOadapter described herein. The ViVOwallet welcome screen 1310 identifies the application and requests the user to log on with a password for authentication purposes. In operation, the screens may be sequenced by the standard buttons found on the typical PTD and depicts typical selections common to financial management applications which include “select credit/debit/ID/other card”, “make transaction”, “review transactions”, “review card status”, and such maintenance functions as “synchronize devices” 1315. The ViVOwallet application may be sequenced to select the pay-and-go feature 1320 for mutual authentication of the cell phone and PTD type PTD and the ViVOadapter, card data transaction processing, and digital receipts within a secure encrypted session. The user may orient the cell phone IR communications component at the ViVOadapter infrared communications component within a typical distance of 1 millimeter to 3 meters. The ViVOadapter will acknowledge the request and establish inter-device communications, exchange mutual authentication processes, and establish a data encryption key for secure data transmission session when wireless and infrared network communication is present. The ViVOwallet application is provided in an embedded version for use with RF proximity chip cards and typically has no user interface for the maintenance and other functions described above. However, these functions are supported by the consumer/card issuer/other authorized party PC or network interface for the RF proximity chip card. Examples of systems utilizing embodiments of the ViVOwallet financial management application are described in the following patent applications, incorporated by reference herein for all purposes: U.S. nonprovisional patent applications Ser. Nos. 09/837,115, and 09/875,555, and no. 10/323,593, filed Dec. 18, 2002.

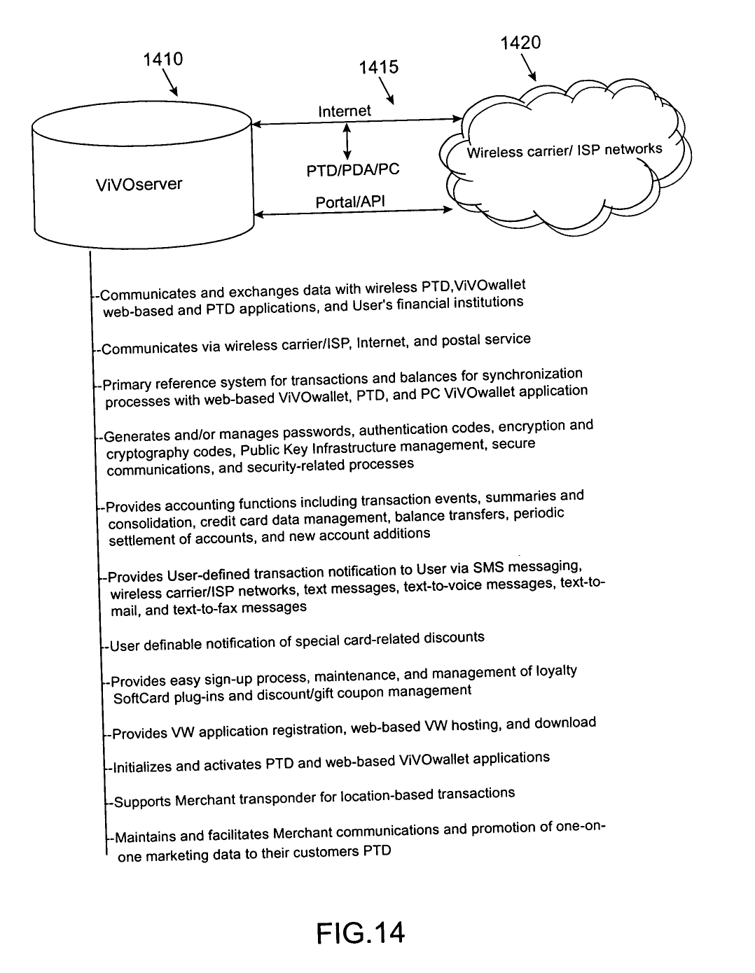

The ViVOadapter will communicate directly with the RF proximity chip card and embedded ViVOwallet financial aggregation application via RF inductive coupled medium and the two devices will effect mutual authentication in a manner transparent to the user depicted in 1330. The user will present the RF proximity chip card to the ViVOadapter within a distance typically specified in ISO 14443 type A and type B protocols and ISO 15693 protocols and for a period of time required to effect mutual authentication, cryptographic routines for key generation and data security, and transmit typical magnetic domain track data typical to credit/debit/ATM/pre-pay/loyalty/member/ID magnetic stripe cards. An additional data string will be appended. This data string will include part or all of a unique message transaction code, message digest, digital signatures, device(s) serial number, ViVOtech, Inc. and authorized third party specific codes, acquirer codes, issuer codes, manufacturer codes, ViVOserver (discussed in FIG. 14 below) specific codes, and/or other authenticator codes for a unique identification or non-repudiation scheme determined by ViVOtech, Inc. and authorized partners.

A benefit of direct transfer of card information via the wireless carrier/ISP or direct to ViVOadapter is the “card present” association defined by the major card issuers. An internet or verbal-based exchange of card data has higher risk assignment due to card security and will incur higher transaction fees and vendor qualification, in addition to partial responsibility for financial loss by the merchant. A “card present” transaction has lower risk assignment because of standard methods of user identification available to the merchant. The transfer of card data via PTD with ViVOwallet application in a secure process will use the non-repudiation schemes established by the PTD and wireless carrier/ISP services and internet security shell (SSL) protocols.

A benefit of the wireless network-based PTD with the ViVOwallet application is that aggregation of an unlimited number of consumer cards, including credit/debit/ATM/pre-pay loyalty/member/ID, can be maintained on the network-based database server and the PTD for access by the consumer. This secure data aggregation will reduce card “bulk” in the consumer's wallet and will also increase security of the data maintained on existing cards.

Another benefit of the wireless network-based PTD with the ViVOwallet application is the ability to effect financial transactions via IR, Short Messaging Service (SMS) protocol and networks, text paging, fax transmission, and via RF on a device-to-device means or via the wireless carrier/ISP network.

Another benefit of this process is the low cost of wireless communication sessions and resultant fees associated with the transaction costs. The wireless carrier/ISP offers cellular data wireless network transaction typically costs less than 90% of the standard wired carriers and with the security of transaction processes by “strong” encryption standards that will ensure lower “card present” transaction losses, described herein, because of the non-repudiation protocols inherent with cell phone and PTD usage with these wireless carrier/ISP services.

An alternate embodiment of the ViVOadapter is the integration of a cellular transceiver device. This embodiment will enable the user to dial the number associated with the ViVOadapter and effect a purchase via direct PTD to ViVOadapter communications, via the wireless carrier/ISP network, or via SMS protocols.

In still another alternate embodiment, the ViVOadapter may be directly connected to the user's PC for use with the typical communications device and media described herein. This alternative embodiment will enable the user to effect secure transactions via the internet and using cryptographic protocols described herein. An advantage of this configuration is the lower risk of identity fraud associated with on-line transactions, and the ability to securely authenticate the user for non-financial internet transactions and other network-based transactions.

FIG. 14 is a simplified descriptive diagram of the ViVOserver™ data management system. FIG. 14 shows one particular embodiment which includes features for the network-based server supportive of the invention. The ViVOserver™ database management system 1410 is responsible for communicating and exchanging user and financial institutions data via the internet 1415 and for the ViVOwallet applications in a secure and private process. It may provide card issuer and card transaction clearing house authorizations via cellular/wireless ISP networks for the ViVOadapter configured with the cellular wireless ISP transceiver embodiment described herein. It may also serve as the primary reference system for pay-and-go transactions and balances for synchronization processes with PTD and PC based ViVOwallet applications and PC based ViVOadapter applications.

The ViVOserver may perform a number of important function, such as communicating and exchanging data with wireless PTD, ViVOwallet applications, and User's financial institutions, and communicating via wireless carrier/ISP and Internet. The ViVOserver may provide the primary reference system for transactions and balances for synchronization processes with PTD and the PC-based ViVOwallet application. The ViVOserver may generates and/or manages passwords, authentication codes, encryption and cryptography codes, manage PKI, secure communications, and security-related processes. The ViVOserver may provide accounting functions including transaction events, summaries and consolidation, credit card data management, balance transfers, periodic settlement of accounts, and new account additions. The ViVOserver may provide transaction notification to User via SMS messaging, wireless carrier/ISP networks, text messages, text-to-voice messages, text-to-email, and text-to-fax messages, in addition to similar protocols to be developed in the future. The ViVOserver may allow user definable notification of special card-related discounts, and provides easy sign-up process for loyalty and member cards. The ViVOserver may generate and/or manages passwords, authentication codes, encryption codes and keys, and maintains the PKI cryptology. The ViVOserver enables the user to manage multiple card and banking accounts and communicates with internet-based PC systems via the internet 1415, and communicates with the ViVOwallet application via the PTD wireless carrier/ISP network 1420. The ViVOserver may communicate with the wireless carrier/ISP networks via a portal/applications program interface.

A benefit of the internet-based ViVOserver is that it will aggregate all of the financial and card information provided by the user and will be, upon request by the user, the intermediary for consolidated payments and settlements. Further, the sender will be mobile or stationary and not restricted to a specific location. Further, the ViVOserver will notify the user of transaction events and will be directed by the user to render invalid all cards referenced on the database in the event of loss or theft of the user's cards. Notification can take the form of at least SMS messaging, text messages, text-to-voice, text-to-e-mail, and text-to-fax.

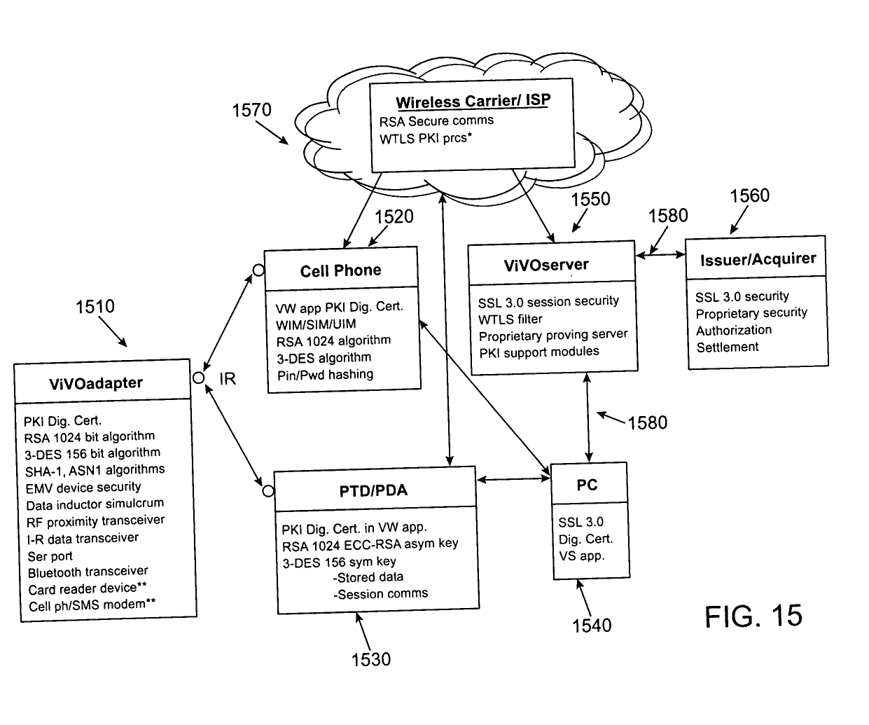

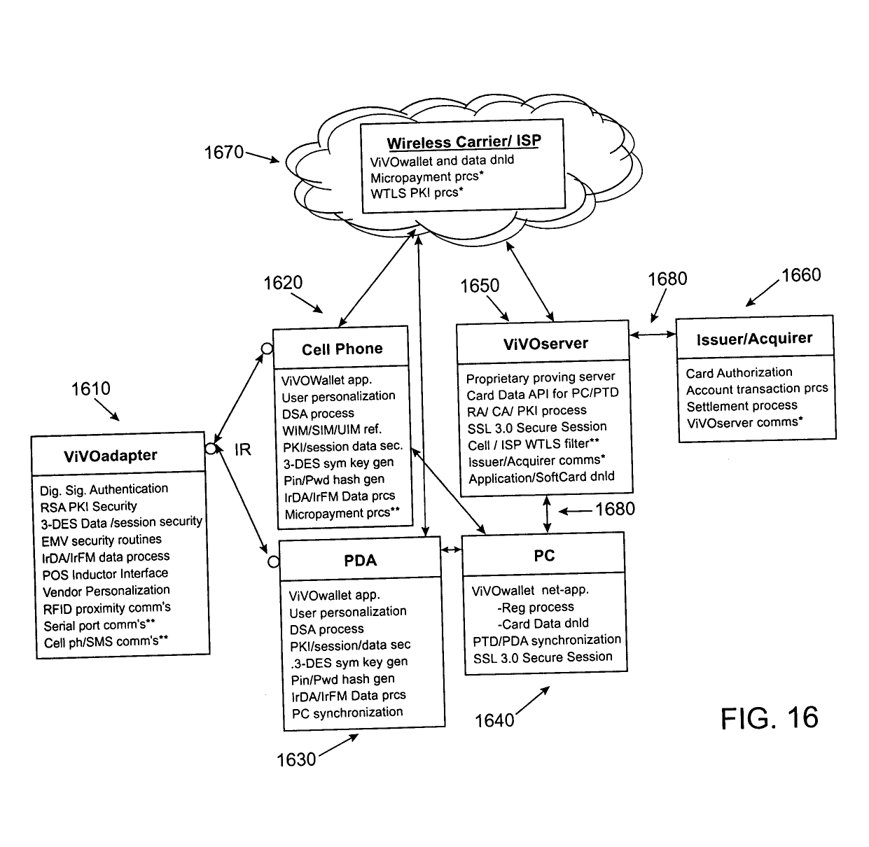

FIG. 15 is a component diagram and FIG. 16 is a functional diagram of the physical devices and systems that will be utilized to implement the present invention that integrates PTD 1620, 1630 with the ViVOwallet financial management application, wireless carrier/ISP data communications network 1670, internet-based ViVOserver 1650, internet-based user's PC 1640, and the merchant's ViVOadapter 1610 modified POS system. The ViVOadapter 1610 may communicate with the RF proximity chip card via inductive coupled RF 14443 type A or type B or 15693 protocols, or other type of transceiver, and with the cell phone 1620 and personal digital assistant (PTD) 1630 via IR, IEEE 802.11(a)(b) or (g), SMS or the wireless carrier/ISP network 1670. The PTD may also communicate via direct cable with the user's PC 1640 for the ViVOwallet and other electronic wallet synchronization purposes and for secure network transactions described herein. The user's PC 1640 may communicate via the internet 1680 with the ViVOserver 1650. The ViVOserver may communicate with the Card Issuer/Acquirer 1660 via the internet 1680 or the cellular/wireless ISP network 1670. The PC based ViVOwallet program may communicate with the ViVOadapter 1610 via the internet and the wireless carrier/ISP network 1670. The ViVOadapter may transmit user's card data described herein to the magnetic card swipe or insert acceptance systems described herein, and may also transmit the data directly to the user's PTD device as described herein.

A benefit of this functional design is the potential integration of RF proximity chip card data communications, IR, and RF transceiver equipment such as IEEE 802.11(a)(b) or (g) and cellular/wireless ISP networks and wired networks into a single device that is substantially permanently installed in the legacy magnetic stripe POS card acceptance systems.

A benefit of this transaction process is the ability of the user to effect a “card-present” financial transaction via near-proximity infrared or by wireless carrier/ISP networks and without presentation of the actual magnetic card. This reduced risk transaction is effected via the transaction and data management security and authentication protocols and procedures enabled by an intelligent transaction device. The “card-present” transaction will result in lower risk assignment by the card issuers and resultant lower transaction fees and merchant qualification.

Another benefit of this transaction process is the capability of the ViVOadapter to temporarily store/cache the magnetic card data introduced to the POS magnetic card reader device and then transmit this data to the user's PTD via infrared, 802.11(a)(b) or (g), and RF proximity 14443 type A and B and 15693 media. Of course, mutual authentication between card data and the user's PTD is required to ensure only magnetic card data assigned by the issuer to the user will be captured and transmitted to the use's PTD via normal secure communications methods. Alternatively, the captured magnetic card data will be transmitted via wireless carrier/ISP, SMS, and internet for installation into the user's PTD device, or for transactions.

Another benefit of this transaction process is the aggregation of the user's magnetic stripe cards via their PTD and home PC. This aggregation will enable greater convenience and greater security achieved through card data encryption measures and by not transporting the physical cards.

Of course, many other configurations of the ViVOadapter enabled equipment are contemplated by the present invention. For example, any PTD device with wireless network capabilities and an integrated infrared communications device will be used with the ViVOwallet application to communicate with the ViVOadapter. Further, a user's mobile PC system with internet access and integrated infrared device will be used in similar manner to the PTD, in addition to the ability of the user to effect a transaction by the ViVOwallet based PC via the internet and wireless carrier/ISP.

Additionally, the ViVOadapter may be placed on the home/office user's PC for on-line purchases with the RF proximity chip card and PTD IR, RF, Bluetooth 802.11(b) and other communications media described herein. In this embodiment, the user will present the RF card or PTD with ViVOwallet application to the ViVOadapter and the secure data will be transferred to the PC ViVOwallet application for secure transmission to the internet-based purchaser, thereby effecting a secure transaction. A benefit of this novel application is the greater security of the RF proximity chip card that is more resistant to fraud and tampering than the standard magnetic strip credit/debit/ATM/pre-pay/loyalty/member/ID card. This will result in lower transaction risks and associated reduction in transaction processing fees.

Further, PTD-based financial applications exist that are similar to the ViVOwallet financial management application and are capable of communications with the ViVOadapter via the infrared component.

Alternate applications are also contemplated to implement the transaction process with the ViVOwallet financial application remotely located on the wireless carrier/ISP server and/or the ViVOserver and remotely controlled by the buyer's cell phone or PTD.

An embodiment of a method for importing information from a magnetic stripe card into a personal trusted device comprises providing a magnetic stripe card reader having a slot and a magnetic head in magnetic communication with the slot. An adaptor structure is provided having a transceiver configured to transmit a signal to a personal trusted device, a memory in communication with the transceiver, and a simulacrum including an inductor. The simulacrum is disposed substantially permanently within the slot such that the inductor is aligned with the magnetic reader head, the simulacrum sufficiently narrow to allow a magnetic stripe card to access the slot and the magnetic head while the simulacrum is present within the slot. A magnetic stripe card is swiped through the slot such that information on the magnetic stripe card is read by at least one of the inductor and the magnetic head. The information is stored in the memory, and the information is transmitted from the adaptor to the personal trusted device utilizing the transceiver.

An embodiment of a method for communicating information from one PTD to another comprises providing a magnetic stripe card reader having a slot and a magnetic head in magnetic communication with the slot. An adaptor structure is provided comprising a transceiver configured to receive a first signal from a first personal trusted device and to transmit a second signal to a second personal trusted device, a memory in communication with the transceiver, and a simulacrum including an inductor. The simulacrum is disposed substantially permanently within the slot such that the inductor is aligned with the magnetic reader head, the simulacrum sufficiently narrow to allow a magnetic stripe card to access the slot and the magnetic head while the simulacrum is present within the slot. Information is transmitted from the first personal trusted device to the memory through the transceiver. The information is stored in the memory, and the information is transmitted from the memory to the second personal trusted device utilizing the transceiver.

Given the above detailed description of the present invention and the variety of embodiments described therein, these equivalents and alternatives along with the understood obvious changes and modifications are intended to be included within the scope of the present invention.

What is claimed is:

1. A method of communicating information to a personal trusted device (PTD), the method comprising:
encrypting information at a source;
communicating the encrypted information to a receiver of a PTD through a first communication channel;
storing the encrypted information in a memory of the PTD;
transmitting a decryption key to the PTD through a second communication channel different from the first communication channel; and
utilizing the decryption key to decrypt the information.

2. The method of claim 2 wherein the first communication channel comprises a short range wireless medium, and the second communication channel is selected from the group consisting of a wired network connection, a long range wireless network connection, a postal channel, and a telephone voice connection.

3. The method of claim 2 wherein communicating the encrypted information comprises transmitting an infra-red signal to the PTD.

4. The method of claim 1 wherein communicating the encrypted information comprises transmitting an RF signal to the PTD, the RF signal conforming to the ISO 14443 type A or B standard, or to the ISO 15693 standard.

5. The method of claim 1 wherein the information comprises financial information, and the decryption key is mailed to the PTD user.

6. The method of claim 5 wherein the decryption key is embedded as a portion of a financial statement.

7. The method of claim 1 wherein the source comprises an interface device including a cryptoprocessor, the method further comprising transmitting the information to the source.

8. The method of claim 7 wherein the information is transmitted to the source from one of a magnetic stripe card, an RF proximity chip card, and a second PTD.

9. The method of claim 7 wherein encrypting the stored information comprises encrypting the information with a key embedded in the interface device.

10. The method of claim 7 further comprising:
requiring a user to enter a security code prior to encrypting the information in the interface device; and
requiring a user to enter the security code into the PTD before accessing the encrypted information.

11. The method of claim I further comprising communicating a notification message to the source upon decryption

12. A method of communicating information to a personal trusted device (PTD), the method comprising:
communicating encrypted information to a receiver of a PTD from a first device;
storing the encrypted information in a memory of the PTD;
communicating a decryption key to the PTD from a second device; and
utilizing the decryption key to decrypt the information.

13. The method of claim 12 wherein the encrypted information is electronically communicated to the PTD from a first device selected from the group consisting of a personal computer, a second PTD, an RF proximity chip card, an interface device, and a server administered by a party responsible for encrypting the information.

14. The method of claim 12 wherein the decryption key is communicated to the PTD by typing in contents of a document mailed to the PTD user.

15. The method of claim 14 wherein the information comprises credit card information and the decryption key is mailed to the PTD user in a credit card billing statement.

16. The method of claim 15 further comprising communicating a notification message to a credit card issuer upon decryption of the credit card data.

17. A method of activating a credit card account for use on a personal trusted device (PTD), the method comprising:
storing in a memory of the PTD encrypted data identifying a credit card account number;
entering a decryption key into the PTD; and
decrypting the data with the decryption key.

18. The method of claim 17 wherein the decryption key is forwarded to the PTD utilizing a different communication channel than is used to forward the encrypted data to the PTD.

19. The method of claim 17 wherein the decryption key is forwarded to the PTD from a different device than is used to forward the encrypted data to the PTD.

20. The method of claim 17 further comprising communicating a notification message to a credit card issuer upon decryption of the credit card data.

21. An apparatus for importing information into a personal trusted device, the apparatus comprising:
a receiver configured to receive information from a source;
a memory in electronic communication with the receiver and configured to store the information;
a processor in electronic communication with the memory and configured to encrypt the information; and
a short range wireless transmitter in electronic communication with the memory and configured to transmit the encrypted information to a PTD.

22. The apparatus of claim 21 wherein the receiver comprises an inductor in magnetic communication with a magnetic card slot.

23. The apparatus of claim 22 wherein the inductor comprises a magnetic reader head.

24. The apparatus of claim 22 wherein the inductor comprises a simulacrum configured to be substantially permanently positioned within a magnetic card slot of an existing magnetic card reader.

25. The apparatus of claim 20 wherein the transmitter is selected from the group consisting of an infrared (IR) transceiver, a BLUETOOTH transceiver, an IEEE 802.11(a), (b), or (g) transceiver, a WiFi-type transceiver, and an RF transceiver configured to communicate with an RF proximity chip card confirming to ISO 14443 type A or B standard, or ISO 15693 standards.

26. The apparatus of claim 25 wherein the receiver and transmitter communicate utilizing infrared radiation and are combined as a single infrared transceiver.

27. The apparatus of claim 25 wherein the receiver and transmitter communicate utilizing RF radiation and are combined as a single RF transceiver.

28. The apparatus of claim 21 further comprising a cryptoprocessor in electronic communication with the memory and configured to encrypt the information.

29. The apparatus of claim 21 further comprising a wired communication port configured to communicate with a network.

30. The apparatus of claim 21 further comprising a long range wireless transceiver configured to communicate with a network.

31. The apparatus of claim 21 further comprising at least one of a keypad, a display, and a printer to facilitate communication with a PTD comprising an RF proximity chip card.
